(19) United States
(12) Patent Application Publication
(10) Pub. No.: US 2026/0299724 A1
(43) Pub. Date: Oct. 1, 2026

(54) TOUCH TYPE PROFILING AND CLASSIFICATION FOR A CAPACITIVE TOUCH INTERFACE

(71) Applicant: Microsoft Technology Licensing, LLC, Redmond, WA (US)

(72) Inventors: Anatoly TSVETOV, Kfar-Yona (IL); Roei Shlomo MENASHOF, Netanya (IL); Oren ISTRIN, Tel Aviv (IL)

(21) Appl. No.: 19/097,533

(22) Filed: Apr. 1, 2025

(51) Int. Cl. G06F 3/041; G06F 3/044; G06F 18/241

(52) U.S. Cl. CPC G06F 3/0418; G06F 18/241; G06F 3/044; G06F 2203/04104; G06F 2203/04106

(57) ABSTRACT

A capacitive touch interface with touch type profiling and classification improves accuracy in classifying touch events, allowing users to interact with touch devices (e.g., touchscreens and touchpads) more naturally. Resources are conserved by avoiding reporting, processing, actions and reversals for non-input touch events. Touch features are extracted from a touch event dataset, e.g., touch location, size, shape, duration, consistency, capacitance intensity, dynamics (e.g., shape change, movement pattern), clustering, palm indication, etc. Touch events are classified (e.g., as touch input, instrument input, palm touch, moisture) based on touch profiles indicated by touch features. For example, a moisture profile can include irregular touch shapes, weak or inconsistent capacitance measurements, and/or an abnormal contact dynamic. Feedback can be provided at touchpoints classified as input and/or non-input. Different feedback can be provided for different classes, such as a moisture indication to the user and/or to the operating system to remove or counteract moisture.

### BACKGROUND

Computing devices often utilize touch input devices, such as touchscreens and touchpads, which are touch-sensitive surfaces that allow users to control the computing devices using their fingers. For example, a touchscreen display on a phone, tablet, or notebook computer allows a user to interact with displayed content by touching a display screen or pad. A touchpad is often utilized in portable computers as an integrated mouse but can also be used to provide additional forms of input. A touchpad can have integrated buttons a user can press or click and/or that can be configured to recognize selections based on gestures, such as tapping a finger on the touchpad once to perform a “select” and tap twice to perform an “open” (which mimics the pressing or double-clicking of a button). Other recognized gestures for touchscreens and touchpads include, for example, sliding or dragging a finger to move a cursor, pinching two fingers to zoom in, separating two fingers to zoom out, swiping to scroll, to switch between applications, etc.

Touchscreens and touchpads often include a microcontroller (e.g., a system on a chip (SoC)) configured to process touch input data received by touch sensors. The microcontroller reports the touch inputs to the operating system or application, which generates feedback. For example, the OS or application can generate displayed content showing user input, such as cursor movements, selections, drawings, etc., while the user interacts with displayed content.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Touch type profiling and classification for a capacitive touch interface is disclosed herein. A capacitive touch interface with touch type profiling and classification improves accuracy in classifying touch events, allowing users to interact with touch devices (e.g., touchscreens and touchpads) more naturally. Resources are conserved by avoiding reporting, processing, actions and reversals for non-input touch events. Touch features are extracted from a touch event dataset, e.g., touch location, size, shape, duration, consistency, capacitance intensity, dynamics (e.g., shape change, movement pattern), clustering, palm indication, etc. Touch events are classified (e.g., as touch input, instrument input, palm touch, moisture) based on touch profiles indicated by touch features. Moisture touches and palm touches can be classified as non-input, even when appearing as fragmented touches resembling finger touches, by profiling and classifying touch types based on touch characteristics. For example, a moisture profile can include irregular touch shapes, weak or inconsistent capacitance measurements, and/or an abnormal contact dynamic. Feedback can be provided at touchpoints classified as input and/or non-input. Different feedback can be provided for different classes, such as a moisture indication to the user and/or to the operating system to remove or counteract moisture. Users can customize touch type profiles and/or touch type sensitivities for touch type classifications. Dynamic adaptations are provided during touch input, such as touch profiling adaptations and/or touch sensitivity adaptations based on touch type detections/classifications and/or based on detected screen and/or ambient environmental conditions.

In an aspect, a computing device comprises a touch device (e.g., touchscreen and/or touchpad). The device includes a data collector configured to generate a dataset associated with a touch event on the touch device. The dataset can be generated by a touch sensor array. Each touch event can be associated with at least one touchpoint on the touch device. The touchpoint(s) may or may not be user input. The device includes a feature extractor configured to determine touch features (e.g., touch characteristics/parameters) from the dataset. Touch features include, for example, touch location, touch size, touch shape, touch duration, touch consistency, capacitance intensity, touch dynamics (e.g., shape change, movement pattern), touch clustering, palm indication, etc. The device includes a classifier configured to classify the touch event as a class in a set of classifications comprising at least user input and moisture input based on a touch profile indicated by the touch features. For example, a moisture touch profile can include irregular touch shapes, weak or inconsistent capacitance measurements, and/or an abnormal contact dynamic. The device includes a handler to respond to the classified touch events. The handler may be configured to respond to touch events classified as moisture, for example, by providing a moisture indication to the user and/or to the operating system.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of an example computing device with a capacitive touch interface touch interface implementing touch type profiling and classification, in accordance with an embodiment.

FIG. 2 shows a block diagram of an example of a touch manager for a touch profiling and classification interface, in accordance with an embodiment.

FIG. 3 shows an example of touch profile-based clustering of fragmented touch inputs on an example touch sensor array, according to an example embodiment.

FIG. 4 shows a flowchart of providing a touch profiling and classification interface, in accordance with an embodiment.

FIG. 5 shows an example interaction diagram for a touch profiling and classification interface, in accordance with an example embodiment.

FIG. 6 shows a flowchart of a process for providing a touch profiling and classification interface, in accordance with an embodiment.

FIG. 7 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Computing devices often utilize touch input devices, such as touchscreens and touchpads, which are touch-sensitive surfaces that allow users to control the computing devices using their fingers. For example, a touchscreen display on a phone, tablet, or notebook computer allows a user to interact with displayed content by touching a display screen or pad. A touchpad is often utilized in portable computers as an integrated mouse but can also be used to provide additional forms of input. A touchpad can have integrated buttons a user can press or click and/or that can be configured to recognize selections based on gestures, such as tapping a finger on the touchpad once to perform a “select” and tap twice to perform an “open” (which mimics the pressing or double-clicking of a button). Other recognized gestures for touchscreens and touchpads include, for example, sliding or dragging a finger to move a cursor, pinching two fingers to zoom in, separating two fingers to zoom out, swiping to scroll, to switch between applications, etc.

Touchscreens and touchpads often include a microcontroller (e.g., a system on a chip (SoC)) configured to process touch input data received by touch sensors. The microcontroller reports the touch inputs to the operating system or application, which generates feedback. For example, the OS or application can generate displayed content showing user input, such as cursor movements, selections, drawings, etc., while the user interacts with displayed content.

Touchscreens and touchpads are sometimes unable to distinguish between user input (i.e., intended user input) and non-user input (e.g., unintended user input). User input includes finger touches and instrument touches. Non-user input includes user palm touches and moisture. While a palm touch can be rejected based on a touch input size larger than a finger, palm touches on capacitive touchscreens may present as multiple smaller touches similar to the size of finger touches, e.g., due to loss of grounding and/or based on the shape of the palm and amount of contact at the time of touch. Moisture touches on a capacitive touchscreen may present similar to one or more finger touches or instrument touches, e.g., including movements.

Capacitive touch devices are widely used, e.g., in smartphones, tablets, and larger touch-based computers. Capacitive touch devices detect touch inputs by measuring changes in the electrical field caused by conductive objects, such as human fingers and touch instruments. However, moisture (e.g., water droplets) can also conduct electricity and alter the capacitive field, resulting in false touch detections. The issue of false touch detections is more pronounced in environments with high humidity, rain, or when the device is exposed to liquids, leading to unintended inputs and degraded user experience.

Inaccurate determinations of user input lead to erratic device behavior and user frustration, e.g., due to user interruption and delay to re-enter user input and/or to correct errant operations based on misinterpretations of user input, as well as excess consumption of energy (e.g., battery depletion) involved in inaccurate reporting and processing of non-user input as if it were user input in addition to erroneous operations and undo operations related to inaccurate determinations of user input.

The inventive technology described herein overcomes these and further deficiencies of the art. In particular, a capacitive touch interface with touch type profiling and classification improves accuracy in classifying touch events, allowing users to interact with touch devices (e.g., touchscreens and touchpads) more naturally. Resources are conserved by avoiding reporting, processing, actions and reversals for non-input touch events. Touch features are extracted from a touch event dataset, e.g., touch location, size, shape, duration, consistency, capacitance intensity, dynamics (e.g., shape change, movement pattern), clustering, palm indication, etc. Touch events are classified (e.g., as touch input, instrument input, palm touch, moisture) based on touch profiles indicated by touch features. Moisture touches and palm touches can be classified as non-input, even when appearing as fragmented touches resembling finger touches, by profiling and classifying touch types based on touch characteristics. For example, a moisture profile can include irregular touch shapes, weak or inconsistent capacitance measurements, and/or an abnormal contact dynamic. Feedback can be provided at touchpoints classified as input and/or non-input. Different feedback can be provided for different classes, such as a moisture indication to the user and/or to the operating system to remove or counteract moisture. Users can customize touch type profiles and/or touch type sensitivities for touch type classifications. Dynamic adaptations are provided during touch input, such as touch profiling adaptations and/or touch sensitivity adaptations based on touch type detections/classifications and/or based on detected screen and/or ambient environmental conditions.

In an aspect, a computing device comprises a touch device (e.g., touchscreen and/or touchpad). The device includes a data collector configured to generate a dataset associated with a touch event on the touch device. The dataset can be generated by a touch sensor array. Each touch event can be associated with at least one touchpoint on the touch device. The touchpoint(s) may or may not be user input. The device includes a feature extractor configured to determine touch features (e.g., touch characteristics/parameters) from the dataset. Touch features include, for example, touch location, touch size, touch shape, touch duration, touch consistency, capacitance intensity, touch dynamics (e.g., shape change, movement pattern), touch clustering, palm indication, etc. The device includes a classifier configured to classify the touch event as a class in a set of classifications comprising at least user input and moisture input based on a touch profile indicated by the touch features. The use of a touch profile has the advantage of allowing collected touch features to be accumulated in the touch profile, thereby enabling more accurate classifications to be made based on accumulated data rather than on a touch event by touch event basis. For example, a moisture touch profile can include irregular touch shapes, weak or inconsistent capacitance measurements, and/or an abnormal contact dynamic. The device includes a handler to respond to the classified touch events. The handler may be configured to respond to touch events classified as moisture, for example, by providing a moisture indication to the user and/or to the operating system.

Advantages or benefits of the embodiments described further herein include more accurate classification of touch data as user input and more accurate rejection of non-user input (e.g., user palm touch, moisture). Energy is conserved by avoiding reporting and processing non-user input. User-experience is improved by improved accuracy in identification of user input. Users can interact with touch devices more naturally without contorting their hands because user-input is identified more accurately and non-user input is rejected more accurately. The temperature differences between fingers, palms, moisture, and touch instruments can be observed and utilized to distinguish between touches regardless of a wide range of ambient and screen environments. The system can be configured for dynamic adaptation and user-customization to maintain accuracy across different users and environments. User accessibility and application-specific interaction (e.g., gaming) can be improved by supporting customization of touch profiles and/or classification sensitivities/thresholds to more accurately identify customized user inputs for one or more touch devices (e.g., touchscreen, touchpad).

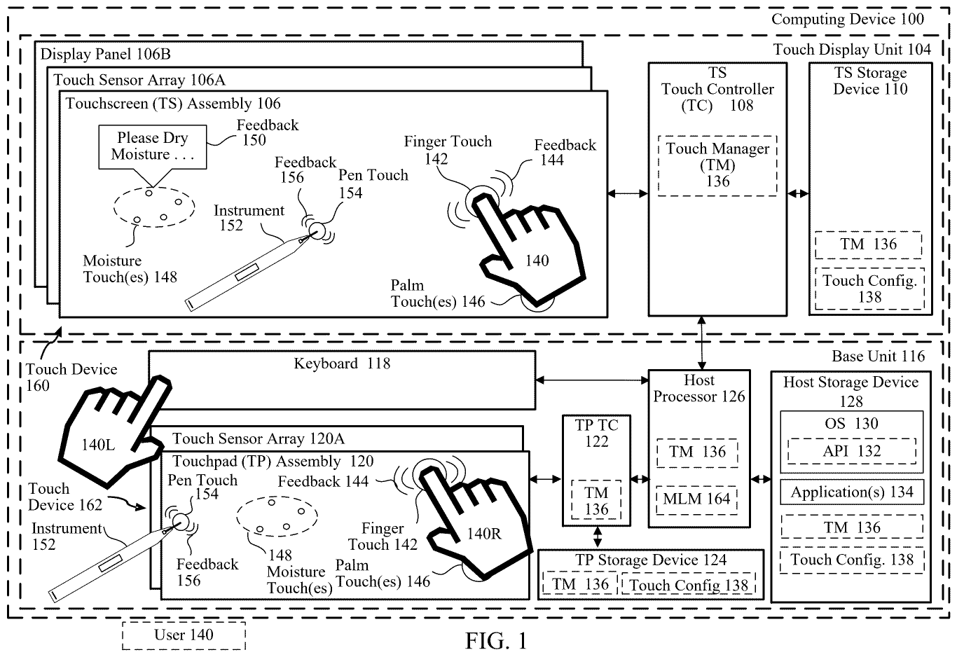

Embodiments disclosed herein can be configured in various ways. For instance, FIG. 1 shows a block diagram of an example computing device 100 with a capacitive touch interface touch interface implementing touch type profiling and classification, in accordance with an embodiment. As shown in FIG. 1, computing device 100 includes a touch display unit 104 and a base unit 116. Touch display unit 104 includes a touch device 160, a touchscreen (TS) touch controller (TC) 108, and a TS storage device 110. Touch device 160 includes a touch screen formed at least of a TS assembly 106 that includes a touch sensor array 106A and a display panel 106B. TS touch controller 108 includes a touch manager 136 and TS storage device 110 stores a touch manager 136 and a touch configuration 138. Base unit 116 includes a keyboard 118, a touch device 162, a touchpad (TP) touch controller (TC) 122, a TP storage device 124, a host processor 126, and a host storage device 128. Touch device 162 includes a touchpad formed at least of a touchpad (TP) assembly 120 that includes a touch sensor array. TP TC 122 includes a touch manager 136. TP storage device 124 stores a touch manager 136 and a touch configuration 138. Host processor 126 includes a touch manager 136 and a machine learning (ML) model 164. Host storage device 128 stores an operating system 130, one or more applications 134, a touch manager 136, and a touch configuration 138. The components of computing device 100 are described in further detail as follows.

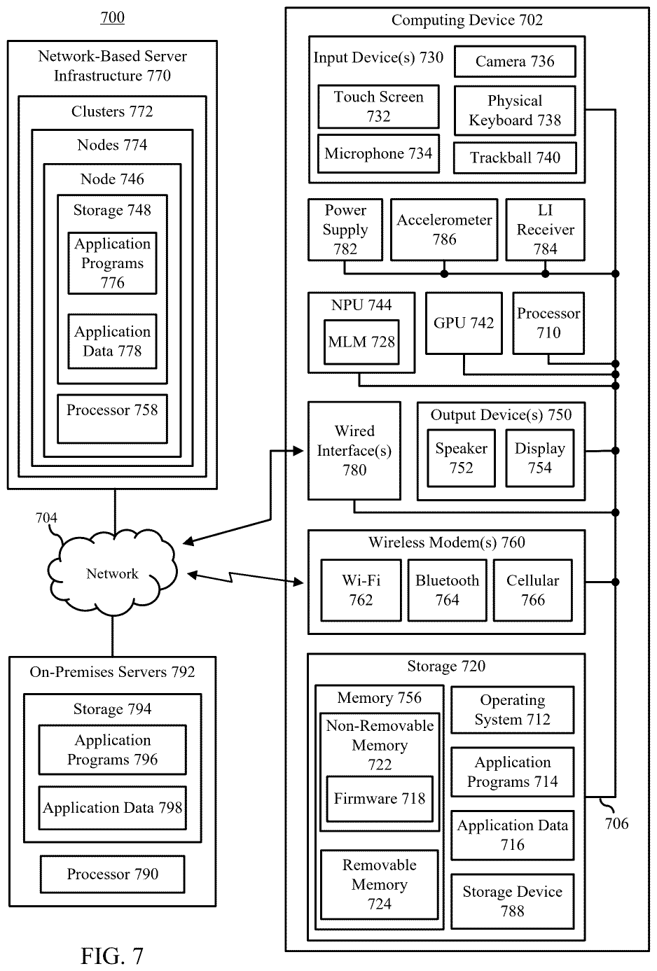

Computing device 100 may be any type of stationary or mobile computing device with a touch input device, including a mobile computer or mobile computing device (e.g., a 2-in-1 device, such as a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server, with at least one touch input device. Example computing device 100 presents one of many possible examples of computing devices. Another example computing device with example features is presented in FIG. 7.

As shown in FIG. 1, computing device 100 (e.g., as shown) may comprise a repositionable notebook computer, a laptop computer, a 2-in-1 computer, a tablet with a case/cover (e.g., with a wired or wireless input device in the case/cover), etc. Computing device 100 includes a touch display unit 104 and a base unit 116. For example, touch display unit 104 (e.g., in an upper/lid portion of computing device 100) and base unit 116 may be physically connected (e.g., by a rotating connector or hinge, a separable connector) and may implement wired communication, or may be physically separate and implement wireless communication (e.g., by a Bluetooth connection). Other computing devices may have the same, similar, or different configuration of touch input devices, with or without other input devices. These components of computing device 100 are described in further detail as follows.

Touch display unit 104 includes a touchscreen assembly 106, a touchscreen (TS) touch controller (TC) 108, and a TS storage device 110. Touch display unit 104 may include one or more user input and output devices, such as touchscreen assembly 106. Other examples of computing devices may have the same, similar, and/or other types and configurations of input devices, such as a peripheral touchscreen.

Touchscreen assembly 106 provides a touch input device (e.g., touch sensitive digitizer shown as touch sensor array 106A), an output device, e.g., a display shown as display panel 106B, among other hardware, firmware and/or software components. The touch digitizer (“digitizer”) comprises capacitive touch sensor element grids or arrays. Touch sensor array 106A may occupy any area (including all) of touchscreen assembly 106 even though not illustrated as such in FIG. 1. Touchscreen assembly 106 includes touch sensor array 106A and display panel 106B.

In some examples (e.g., as shown in FIG. 1), touchscreen assembly 106 may comprise, from bottom to top, display panel 106B, touchscreen sensor array 106A, and cover glass that user 140 touches, e.g., with layers of transparent adhesive between the display panel 106B, touchscreen sensor array 106A, and cover glass. Touchscreen sensor array 106A and cover glass may be substantially transparent, or with wires, electrodes, and sensor sufficiently small so as to be unnoticeable to most human vision.

The display panel 106B may be, for example, a liquid crystal display (LCD) or a light emitting diode (LED) display. Display panel 106B may be driven, for example, by a graphics processing unit (GPU) (not shown). User 140 interacts with content displayed by display panel 106B, for example, by touching touchscreen assembly 106, which is detected by touch sensor array 106A. Further examples of display and GPU are discussed in FIG. 7.

The touchscreen touch digitizer (e.g., touch sensor array 106A) comprises a capacitive type of touch digitizer, e.g., projected capacitance (mutual or self), in-cell, on-cell, out-cell, etc. The touchscreen touch digitizer (e.g., touch sensor array 106A) is configured to detect touch, for example, via capacitive coupling with an instrument (not shown), a finger, a palm, moisture, etc. in close proximity to touchscreen assembly 106 that results in capacitance at one or more locations of touch sensor array 106A. The detection pitch or resolution of touch sensor array 106A may be, for example, fractional to multiple mm.

Touch sensor(s) in touch sensor array 106A detect locations where touch events occur (e.g., where a user finger, instrument, palm, moisture touch touchscreen assembly 106). Capacitive touchscreens work similarly to capacitive touchpads. Touch sensor(s) utilizing capacitive technology maintain an electrical charge across touch sensor array 106A. A touch disrupts the charge in the area touched. Locations of connections may be indicated by x, y coordinates on the touch sensor array 106A, which may be mapped to the display panel 106B. Depending on the application 134 or OS 130 that user 140 is interacting with, the user's finger movement across the touch sensor array 106A can be translated on display panel 106B into a selection, a resizing, a drawing, a cursor movement, etc.

Pressure sensor(s) (not shown) may detect the pressure applied during a touch. Pressure sensor(s) may be integrated with touch sensor(s) or may comprise discrete pressure sensors. Different levels of force applied by a user are reflected in the differences between signals (e.g., signal magnitudes) generated by pressure sensor(s).

Touchscreen (TS) Touch controller (TC) 108 (e.g., a programmed processor executing all or part of TM 136) controls at least the touch digitizer of touchscreen assembly 106 (e.g., touch sensor array 106A). TS TC 108 is a microcontroller, which is a computer on a chip (e.g., an integrated circuit), including one or more processors, memory, and programmable inputs/outputs (I/O) configured to implement, e.g.,, among other functions, the touch interface, e.g., by executing all or part of TM 136. TS TC 108 may be configured to process touch sensor data, e.g., periodically. For example, TS TC 108 may be configured to process touch sensor data every x us or ms to provide a touchscreen interface for user 140.

TS TC 108 may be configured to receive and process touch signals detected by touch sensor array 106A. TS TC 108 may process touch data based on TM 136, which may be configured by touch configuration 138. TS TC 108 may execute all or a portion of TM 136. TS TC 108 may send processed touch signal reports to host processor 126, e.g., for processing relative to OS 130 and/or one or more applications that user 140 may be interacting with via touchscreen assembly 106, e.g., using left hand 140L or right hand 140R.

TS TC 108 may control modes of operation of touchscreen assembly 106. Touchscreen assembly 106 may have a plurality of touch detection modes, e.g., touch or passive mode, active or pen mode, which may be implemented, at least in part, by TC 108. TC 108 may (e.g., in a touch or passive instrument mode), for example, drive a signal on at least one antenna (e.g. X or Y, row or column, vertical or horizontal portion of a grid) in the touch digitizer portion of touchscreen assembly 106 (e.g., touch sensor array 106A), which may project an electric field over touchscreen assembly 106, and monitor the other antenna/electrode for changes (e.g. caused by a conductive pattern in proximity to touchscreen assembly 106). Signal changes may result in detected signals, each with an associated position and intensity/magnitude. TS TC 108 may (e.g., in an active instrument mode), for example, not drive a signal on an antenna and may (e.g. instead) monitor for (e.g. capacitively coupled) active signals in the touch digitizer portion of touchscreen assembly 106 (e.g., touch sensor array 106A), where each detected signal may have an associated position and intensity/magnitude.

Touchscreen assembly 106 and TS TC 108 may generate positive and negative binary large objects (BLOBs) representative of the area, size, and location of detected touches, which may be accompanied by additional information associated with the BLOBs. The determination of touch inputs may be configured, e.g., by a user, and/or dynamically adapted (e.g., by TM 136 executed by TS TC 12 and/or host processor 126). For example, touchscreen assembly 106 and TS TC 108 may detect touch based on one or more (e.g., adaptable and/or configurable) sensitivity (e.g., signal intensity) thresholds (e.g., stored in touch configuration 138). In some examples, TS TC 108 may be configured to report touches (e.g., BLOBs) and associated data to OS 130, e.g., executed by host processor 126. In some examples, TS TC 108 may be configured to process touch data to confirm that touch data represents a touch before reporting confirmed touches to OS 130.

TS storage device 110 may store touch manager (TM) 136 and touch configuration 138 used by TM 136. TS TC 108 may load and execute executable instructions in TM 136, as configured by touch configuration 138. TS storage device 110 may comprise any of one or more types of memory, e.g., non-removable memory, removable memory, random access memory (RAM), read only memory (ROM), flash memory, a solid-state drive (SSD), a hard disk drive (e.g., a disk drive for reading from and writing to a hard disk), and/or other physical memory device types.

TM 136 (e.g., executed by TS TC 108) may control sampling of touch sensor array 106A. TM 136 controls processing of the samples to classify any touch events in the samples according to classes in a set of classifications, such as finger, palm, instrument, moisture, etc. TM 136 implements touch profiling and classification (e.g., machine learning (ML) classification) of touch events, for example, by analyzing touch characteristics, such as shape, area, capacitance intensity, contact dynamics, temporal characteristics, and spatial clustering, which may be combined with adaptive profiling and/or classification (e.g., adaptive thresholds).

Base unit 116 includes a keyboard 118, a touchpad (TP) assembly 120, a TP touch controller (TC) 122, a TP storage device 124, a host processor 126, and a host storage device 128. Base unit 116 may include one or more integrated and/or peripheral user input devices, such as keyboard 118 and touchpad assembly 120. Other examples of computing devices may have the same, similar, and/or other types and configurations of input devices, such as a peripheral touchpad. Note that touchpad and trackpad are used interchangeably herein.

Keyboard 118 is an input device that user 140 can use to provide input to computing device 100. In some examples, one or more keys may be programmed to customize operation of TM 136 (e.g., for a particular application or user) for touch inputs detected by touchscreen assembly 106 and/or touchpad assembly 120.

Touchpad assembly 120 includes a touchpad touch digitizer (“digitizer”) (e.g., touch sensor element grids or arrays) among other hardware, firmware, and/or software components. Touchpad assembly 120 provides a touch input device (e.g., touch sensitive digitizer shown as touch sensor array 120A). Touchpad assembly 120 is an input device that user 140 can use to provide a variety of inputs to computing device 100, such as controlling a cursor, making selections, drawing, zooming in or out, etc. An example touchpad in a notebook computer (e.g., touchpad assembly 120) may be, for example, approximately 90 mm×150 mm (3½ inches×6 inches). In some examples (e.g., as shown in FIG. 1), touchpad assembly 120 may comprise, from bottom to top, touchscreen sensor array 120A and a cover material that user 140 touches.

The touchpad touch digitizer (e.g., touch sensor array 120A) may comprise any type of touch digitizer, e.g., projected capacitance (mutual or self), in-cell, on-cell, out-cell, etc. The touchpad touch digitizer (e.g., touch sensor array 120A) may be configured to detect touch, for example, via capacitive coupling with an instrument, a finger, a palm, moisture, etc. in close proximity to touchpad assembly 120 that results in capacitance at one or more locations of touch sensor array 120A. The detection pitch or resolution of touch sensor array 120A may be, for example, fractional to multiple mm.

Touch sensor(s) in touch sensor array 120A detect locations where a user touches touchpad assembly 120. Capacitive touch sensor array 120A may work similarly to capacitive touch sensor array 106A. Touch sensor(s) utilizing capacitive technology maintain an electrical charge across touch sensor array 120A. A touch disrupts the charge in the area touched. Locations of connections may be indicated by x, y coordinates on the touch sensor array 120A, which may be mapped to the display panel 106B to provide visual feedback of user operations. Depending on the application 134 or OS 130 that user 140 is interacting with, the user's finger movement across the touch sensor array 120A can be translated on display panel 106B into a selection, a resizing, a drawing, a cursor movement, etc.

Pressure sensor(s) (not shown) may detect the pressure applied during a touch. Pressure sensor(s) may be integrated with touch sensor(s) or may comprise discrete pressure sensors. Different levels of force applied by a user are reflected in the differences between signals (e.g., signal magnitudes) generated by pressure sensor(s).

Touchpad (TP) Touch controller (TC) 122 (e.g., a programmed processor executing all or part of TM 136) controls at least the touch digitizer of touchpad assembly 120 (e.g., touch sensor array 106A). TP TC 122 is a microcontroller, which is a computer on a chip (e.g., an integrated circuit), including one or more processors, memory, and programmable inputs/outputs (I/O) configured to implement, e.g., among other functions, touch-sensing touchpad interface, e.g., by executing all or part of TM 136. TP TC 122 may be configured to process touch sensor data, e.g., periodically. For example, TP TC 122 may be configured to process touch sensor data every x us or ms to provide a touchpad interface for user 140.

TP TC 122 may be configured to receive and process touch signals detected by touch sensor array 120A. TP TC 122 may process touch data based on TM 136, which may be configured by touch configuration 138. TP TC 122 may execute all or a portion of TM 136. TP TC 122 may send processed touch signal reports to host processor 126, e.g., for processing relative to OS 130 and/or one or more applications that user 140 may be interacting with via touchpad assembly 120, e.g., using left hand 140L or right hand 140R.

TP TC 122 may control modes of operation of touchpad assembly 120. Touchpad assembly 120 may have a plurality of touch detection modes, e.g., touch or passive mode, active or pen mode, which may be implemented, at least in part, by TP TC 122. TP TC 122 may (e.g., in a touch or passive instrument mode), for example, drive a signal on at least one antenna (e.g. X or Y, row or column, vertical or horizontal portion of a grid) in the touch digitizer portion of touchpad assembly 120 (e.g., touch sensor array 120A), which may project an electric field over touchpad assembly 120, and monitor the other antenna/electrode for changes (e.g. caused by a conductive pattern in proximity to touchpad assembly 120). Signal changes may result in detected signals, each with an associated position and intensity/magnitude. TP TC 120 may (e.g., in an active instrument mode), for example, not drive a signal on an antenna and may (e.g. instead) monitor for (e.g. capacitively coupled) active signals in the touch digitizer portion of touchscreen assembly 120 (e.g., touch sensor array 120A), where each detected signal may have an associated position and intensity/magnitude.

Touchpad assembly 120 and TP TC 122 may generate positive and negative BLOBs representative of the area, size, and location of detected touches, which may be accompanied by additional data associated with the BLOBs. The determination of touch inputs (e.g., and associated thermal data) may be configured, e.g., by a user, and/or dynamically adapted (e.g., by TM 136 executed by TP TC 122 and/or host processor 126). For example, touchpad assembly 120 and TP TC 122 may detect touch based on one or more (e.g., adaptable and/or configurable) sensitivity (e.g., signal intensity) thresholds (e.g., stored in touch configuration 138). In some examples, TP TC 122 may be configured to report touches (e.g., BLOBs) and associated data to OS 130, e.g., executed by host processor 126. In some examples, TP TC 122 may be configured to process touch data to confirm that touch data represents a touch before reporting confirmed touches to OS 130.

TP storage device 124 may store touch manager (TM) 136 and touch configuration 138 used by TM 136. TP TC 122 may load and execute executable instructions in TM 136, as configured by touch configuration 138. TP storage device 124 may comprise any of one or more types of memory, e.g., non-removable memory, removable memory, random access memory (RAM), read only memory (ROM), flash memory, a solid-state drive (SSD), a hard disk drive (e.g., a disk drive for reading from and writing to a hard disk), and/or other physical memory device types.

Host processor 126 may execute executable instructions in OS 130, application(s) 134, and/or TM 136. Further examples of host processor 126 and host storage device 128 are shown in FIG. 7.

Host storage device 128 may store an operating system (OS) 130, which may include application programming interface (API) 132, application(s) 134, touch manager (TM) 136, and/or touch configuration 138 used by TM 136. Host storage device 128 may comprise any of one or more types of memory, e.g., non-removable memory, removable memory, random access memory (RAM), read only memory (ROM), flash memory, a solid-state drive (SSD), a hard disk drive (e.g., a disk drive for reading from and writing to a hard disk), and/or other physical memory device types.

Host processor 126 loads and executes OS 130, which provides overall operation of computing device 100. OS 130 may provide a user interface for user 140 to configure operation of TM 136 (e.g., configure touch configuration 138) to process touch inputs detected by TS assembly 106 and/or TP assembly 120. Additional discussion of OS 130 is provided in discussion of FIG. 7 (e.g., OS 712). Processor 126 may load and execute API 132, which can be configured to support dynamically adapted and/or customized operation of touch-sensing touch detection and processing implemented by application(s) 134 and/or TM 136.

Processor 126 loads and executes application(s) 134, for example, in response to user selection of application(s) 134. Application(s) 134 may include, for example, a word processing program, a spreadsheet program, a game, etc., that user 140 can interact with through TS assembly 106 and/or TP assembly 120. Application(s) 134 may provide a user interface for user 140 to configure operation of TM 136 (e.g., configure touch configuration 138) to apply to touch inputs detected by TS assembly 106 and/or TP assembly 120.

Processor 126 may load and execute TM 136, for example, during boot up of computing device 100. TM 136 is configured to provide a touch interface in concert with TS assembly 106 and/or TP assembly 120. In various examples, TM 136 may be implemented in hardware, hardware combined with one or both of software and/or firmware, and/or as program instructions encoded on computer-readable storage media, configured to perform functions and/or operations described herein for a touch interface in association with user interaction with touchscreen assembly 106 and/or touchpad assembly 120. TM 136 may provide a user interface for user 140 to configure operation of TM 136 (e.g., configure touch configuration 138) to apply to touch inputs detected by TS assembly 106 and/or TP assembly 120.

In various examples, application(s) 134, operating system (OS) 130, virtual machines (VMs) (not shown), etc., may be executed, hosted, and/or stored on computing device 100 or via one or more other computing devices via network(s) (e.g., not shown). Computing device 100 (e.g., via TS TC 108, TP TC 122, and/or host processor 126) executes one or more processes. A process is any type of executable (e.g., binary, program, application) that is being executed by computing device 100 (e.g., via TS TC 108, TP TC 122, and/or host processor 126, and/or the like).

As shown in FIG. 1, user 140 interacts with integrated and/or peripheral input and output devices associated with computing device 100. In various examples, the interactive input devices include one or more touch-sensing touch devices, such as TS assembly 106 and TP assembly 120. User interactions include, for example, touching touchscreen assembly 106, typing on keyboard 118, and/or touching touchpad assembly 120. User 140 can provide input, for example, by hand (e.g., touch 132) and/or by input device (e.g., stylus, not shown). User input may be reflected in updates to imagery displayed by display panel 106B.

A user 140, whose hands are represented as a left hand 140L and a right hand 140R, uses touchscreen assembly 106 and touchpad assembly 120 for input in response to imagery shown by display panel 106B in the touchscreen assembly 106 portion of touch display unit 104. As shown on TS assembly 106 and on TP assembly 120, moisture 148 may result in detection of a touch (e.g., a moisture touch 148) by touch sensor array 106A. Moisture touch 148 may occur in a humid environment, such as user 140 walking in the rain using a handheld computing device 100, e.g., a smartphone, or working outside or indoors in a humid area with a notebook computer. Moisture may be detected as one or more droplets smaller than the size of a finger touch or similar to the size of a finger touch, e.g., with or without movement. Also shown on TS assembly 106 and TP assembly 120, the user 140 uses the right hand 140R to make a finger touch 142 as an intentional touch and in so doing makes an unintentional palm touch 146. As shown, the palm touch may be detected as multiple touches similar to finger touches rather than as a single large touch more indicative of a palm. The user makes another unintended palm touch on the TP assembly 120 with the left hand 140L while typing on keyboard 118. Also shown in FIG. 1, a user may provide instrument input (e.g., pen touch) 154 using a passive or active touch instrument 152.

As described herein, the touch interface implemented by TS assembly 106 and TM 136 and the touch interface implemented by TP assembly 120 and TM 136 are configured to accurately identify finger touch 142 and pen touch 154 as user input and to reject palm touch 146 and moisture touch 148 as non-user input by evaluating the detected touches based on touch profiles indicated by touch datasets generated by touch sensor array 106A and/or touch sensor array 120A and/or based on features extracted from the touch datasets. The touch interfaces (e.g., by operation of TM 136) classify a detected touch as user input class (e.g., finger touch, instrument touch) or non-user input class (e.g., palm touch, moisture touch), for example, based on whether the touch profile (e.g., set of touch features) falls within the touch profile of a finger touch, instrument touch, palm touch, moisture touch or other defined touch classification. The touch event classifications may be analyzed (e.g., post-processed), for example, based on a probability (e.g., confidence level) associated with each classification against one or more classification thresholds, for example, to reach a final classification determination. The generation of a probability has the advantage of being a numerical value that can be compared against predetermined threshold values for meeting classifications, enabling repeatable touch determination results. The touch profiles and/or touch classification sensitivities may be dynamically adjusted (e.g., based on detected environmental parameters) and/or user-configured (e.g., customized).

As shown in FIG. 1, feedback 144, feedback 150, and/or feedback 156 may be provided at locations (e.g., touchpoints) where a touch event (e.g., touch input) occurred or at another location with reference to a touch event. Feedback may be visual, haptic, etc. For example, a visual effect may be displayed by display panel 106B at the location of finger touch 142 and/or pen touch 154. For example, a moisture notice may be displayed by display panel 106B at the location of moisture touch(es) 148 on TS assembly 106 or in any location on TS assembly 106 for moisture touch(es) 148 on TP assembly 120. A moisture notice may, for example, encircle or otherwise direct user's attention to the location of one or more moisture touches on TS assembly 106 and/or TP assembly 120. A moisture notice may, for example, request that user 140 dry moisture at one or more locations on TS assembly 106 and/or TP assembly 120.

Computing device 100 (e.g., via TS TC 108, TP TC 122, and/or host processor 126) may be configured to execute OS 130, API 132, application(s) 134, and/or touch manager (TM) 136, for example, to operate the touch interface with touch type profiling and classification.

Touch manager (TM) 136 manages operations performed by the touch interface(s). TM 136 can be centralized or distributed. Executable versions of TM 136 are shown in dashed lines, e.g., stored in TS storage device 110, TP storage device 124, and/or host storage device 128, and executed in TS TC 108, TP TC 122, and/or host processor 126. The dashed lines indicate that operations performed by TM 136 can be centralized or distributed. For example, powerful microcontrollers TS TC 108 and TP TC 122 may be configured to perform most or all operations of TM 136 while less capable microcontrollers TS TC 108 and TP TC 122 may perform little to no operations of TM 136. Instead, host processor 126 may be configured to perform most or all operations of TM 136. In some examples, TS TC 108 and/or TP TC 122 may be configured to classify detected touch inputs as user input (e.g., finger touch 142, pen touch 154) or non-user input (e.g., palm touch 146, moisture touch 148) based on touch profiles indicated by touch event datasets in order to avoid consuming time and energy reporting non-touch inputs to OS 130 executed by host processor 126, thereby reducing the number of reports, while host processor 126 may be configured to interpret user intent and respond to the reported touches. In some examples, TS TC 108 and/or TP TC 122 may be configured to report touch data to OS 130 and host processor 136 (e.g., or a neural processing unit (NPU), such as NPU 744 in FIG. 7) may be configured to execute the classifier portion of TM 136 (e.g., as machine-learning (ML) model 164) configured to classify the touch data with zero or more touch events as zero or more user inputs (e.g., finger touches), palm touches, instrument touches, moisture touches, and/or other classes, e.g., with or without classifying/interpreting a meaning (e.g., user intent) of the touch input(s) (e.g., finger touches, instrument touches).

Operations of TM 136 can include obtaining, determining, and managing touch configuration 138, which is also shown (e.g., by dashed lines) to be centralized or distributed for storage and utilization in TS storage device 110, TP storage device 124, and/or host storage device 128.

The touch interface (e.g., via TM 136) can be configured to dynamically adjust touch profiles, touch determination sensitivity (e.g., threshold(s)) of TS assembly 106 and/or TP assembly 120 based on, for example, detected/processed finger, palm, instrument, and/or moisture touches, screen and/or ambient environmental conditions (e.g., humidity or moisture detection). The dynamic adjustments may be stored, for example, in the prevailing touch configuration 138 applied by TM 136 to evaluate touch datasets.

TM 136 (e.g., executed by TS TC 108, TP TC 122, and/or host processor 126) can be configured to control sampling of TS touch sensor array 106A and/or TP touch sensor array 120A. TM 136 can be configured to control processing of the samples to classify any touch events in the samples according to classes in a set of classifications, such as finger, palm, instrument, moisture, and/or other classes. TM 136 implements touch profiling and classification (e.g., machine learning (ML) classification) of touch events, for example, by analyzing touch characteristics, such as shape, area, capacitance intensity, contact dynamics, temporal characteristics, and spatial clustering. TM 136 may be configured to implement adaptive and/or user-customized touch profiling (e.g., set of characteristics that characterize each touch type) and/or touch classification (e.g., adaptive classification thresholds). For example, TM 136 can be configured to provide one or more user interfaces for feedback and/or customization. TM 136 may be configured to provide notification/feedback to users (e.g., visual and/or haptic feedback), operating system 130, and/or application(s) 134 to respond to detection (e.g., classification) of moisture touches. For example, OS 130 and/or application(s) 134 may be configured to adapt displayed information to counteract moisture, e.g., relocate a user interface so that user input is not interfered with by moisture.

Classification of detected touches may be performed in one or more steps/operations. For example, a determination whether to classify touch input data as a user input type or non-user input type may be based on a touch profile, e.g., a set of features extracted from a touch dataset. A touch classifier may be configured to classify each touch event represented by a touch profile (e.g., set of touch features) extracted from touch event datasets as a class selected from a set of classes, such as finger touch, palm touch, instrument/pen touch, moisture touch, moisture cluster (e.g., for multiple touch inputs/events), palm cluster (e.g., for multiple touch inputs/events), etc. A classifier may interpret touch events individually and/or collectively (e.g., as clusters of related touch events). Features may be weighted for importance in classification. The weights may be adaptable and/or customizable to change the sensitivities of various features. The classes may include one or more user input classes and one or more non-user input classes. Each classification of a one or more touchpoints (e.g., locations of touch events) in a touch dataset may be accompanied by a probability (e.g., a confidence level) that the classification is accurate.

An analyzer (e.g., performing post processing) may evaluate each classification, for example, by comparing the associated probability to a classification threshold. The classes may share a common threshold or one or more classes may have independent thresholds, which may be the same or different. The thresholds (e.g., classification sensitivities) may be configurable, for example, dynamically adaptable and/or user customizable. The classifier analyzer may function as a filter, e.g., an accuracy filter. The classifier may be configured to classify a plurality of fragmented touch events as non-touch inputs (e.g., a cluster of moisture or palm touch/contact points) based on feature similarities among the plurality of fragmented touch events/inputs.

The classifier(s) in TM 136 may operate based on touch configuration 138, which may include dynamic adaptations/adjustments and/or user configuration/customization. Touch configuration 138 can include configuration (e.g., profile) information, such as, for example, adaptivity settings, customization settings, training information (e.g., machine-learning labeled features), machine-learned information, dynamically adjusted information, and/or user-configured touch information, such as touch profiles (e.g., sets of characteristics with values, with or without weights, that characterize a type/class) and/or touch sensitivities (e.g., classification thresholds). For example, a profile may indicate values (e.g., value range) for each set of class characteristics, such as touch size(s), touch shape(s), capacitance intensities, dynamics (e.g., movements), temporal characteristics (e.g., touch time, touch consistency), cluster characteristics, etc. Profile values may include upper and/or lower range thresholds and/or weights for each class, such as finger touch, palm touch, instrument touch, moisture touch, moisture cluster, palm cluster, etc. Profile values may include values indicating difference (delta) thresholds between one or more user inputs (e.g., finger touch or instrument touch) and/or between non-user inputs (e.g., palm touch or moisture touch), and/or the like.

User customization may vary touch profiles and/or classifications. For example, while finger touches are usually deemed user input (e.g., intended touch) and palm touches are usually deemed non-user input (e.g., unintentional touch), users may provide user settings via direct input and/or via training that can change the size, shape, and/or other features (e.g., touch profile parameters/characteristics) utilized to detect each of multiple touch classes from touch profiles extracted from touch datasets. Users may be motivated to provide user settings/customization to adjust configuration/operation of a touch profiling and classification user interface, for example, based on accessibility, such as to overcome limitations in hand and/or finger usage, based on application-specific reasons, such as gaming or word processing, and/or based on environment-specific reasons, such as working in a hot, humid environment or a cold, dry environment.

Dynamic adaptations may vary touch profiles and/or classifications. OS 130, application(s) 134, and/or TM 136 may, e.g., additionally or alternatively, dynamically adapt touch configuration 138 used by TM 136, for example, based on processing of detected touch inputs (e.g., differentiations between finger, palm, instrument, moisture touches), detected ambient environment, detected screen conditions, etc.

Computing device 100 may include software and/or hardware interfaces for applications and/or users 140 to adapt and/or configure (e.g., customize) operation of the touch interfaces that users 140 interact with via touchscreen assembly 106 and/or touchpad assembly 120. Examples of software interfaces include operating system (OS) application programming interface (API) 132, application(s) 134, and TM 136. API 132 allows a program, such as application(s) 134 and/or TM 136, to determine or accept (e.g., from users 140) touch configuration 138 to adapt or configure operation of TM 136, touchscreen assembly 106, and/or touchpad assembly 120. One or more user interfaces implemented by TM 136, application(s) 134, and/or OS 130 may be configured to allow user 140 to navigate and select/specify/configure user settings for touch profiling and classification for touchscreen assembly 106 and/or touchpad assembly 120. User configuration and/or dynamic adaptation of operating parameters may customize the touch interface, for example, to improve differentiation of touch inputs and non-touch inputs.

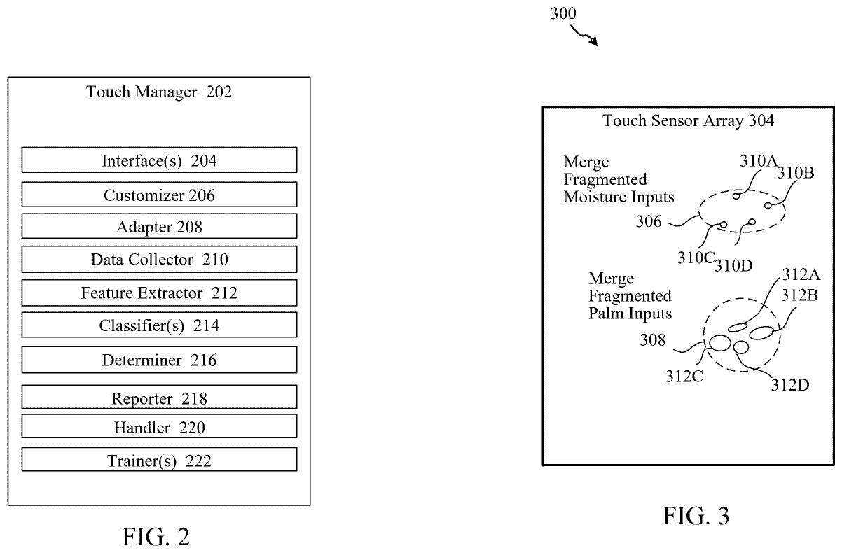

Touch manager (TM) 136 of FIG. 1 may be configured in various ways. For instance, FIG. 2 shows a block diagram of an example of a TM 202 for a touch profiling and classification interface, in accordance with an embodiment. TM 202 is an example of TM 136 shown in FIG. 1. TM 202 may be implemented in hardware, firmware, and/or executable software, which may be executed with respect to a touchscreen, for example, by TS TC 108 and/or host processor 126 and may be executed with respect to a touchpad, for example, by TP TC 122 and/or host processor 136. TM 202 shows one of many possible examples of operational components for a touch profiling and classification interface. Other examples may implement the same or different operational components. As shown in FIG. 2, TM 202 includes interface(s) 204, a customizer 206, an adapter 208, data collector 210, feature extractor 212, classifier(s) 214, determiner 216, reporter 218, handler 220, and trainer(s) 222. The components of TM 202 are described in further detail as follows.

Interface 204 may be configured to access/receive input and access/provide output for operations of TM 202. Interface 204 may include one or more different types of interfaces, which may be wired or wireless. For example, interface 204 may read information from and write information to one or more storage devices, such as TS storage device 110, TP storage device 124, and/or host storage device 128. Interface 204 may provide (e.g., send/transmit) reports (e.g., classified or unclassified touch event BLOBs) generated by reporter 218 to OS 130. Interface 204 may receive and store (e.g., buffer) touch data obtained by data collector 210. Interface 204 may provide touch data to feature extractor 212, e.g., and write extracted feature sets to storage device(s). Interface 204 may access and provide touch features to classifier(s) 214 generated by feature extractor 212 or labeled features on behalf of trainer(s) 222. Interface 204 may access and provide classified touches to handler 220 for analysis/determination of and response to user intent, e.g., relative to content (e.g., provided by OS 130 and/or application(s) 134) displayed by display panel 106B that user 140 appears to have interacted with by the interpreted touch event(s) and/or handling of non-user input, such as providing feedback for detected moisture.

Customizer 206 may be configured to allow user 140 to customize (e.g., directly or indirectly) touch profiles, feature weights, and/or classification thresholds, for example, based on accessibility and/or application-specific activities (e.g., word processing, gaming). User 140 may be motivated to provide user settings/customization to adjust configuration/operation of a touch profiles and/or classifications, for example, based on accessibility, such as to overcome limitations in hand and/or finger usage, based on application-specific reasons, such as gaming or word processing, and/or based on environment-specific reasons, such as working in a hot, humid environment or a cold, dry environment. Customizer 206 can improve user accessibility and application-specific interaction (e.g., gaming) by supporting customization of touch to more accurately identify user inputs for one or more touch devices (e.g., touchscreen, touchpad). Customizer 206 may be configured to allow user 140 to navigate a user interface and select/specify/configure user settings for touch-based user input detection for touchscreen assembly 106 and/or touchpad assembly 120. User configuration of operating parameters may have an objective to improve differentiation of touch inputs and non-touch inputs by user 140. Customizer 206 may provide a user interface or may utilize an interface provided by interface 204. For example, customizer 206 may permit user 140 to provide user settings via direct input and/or via training that can change one or more profiling/classification characteristics, such as the touch size, shape, duration, consistency, capacitance intensity, dynamics (e.g., shape change, movement pattern), clustering, palm indication, and/or other parameter(s) utilized by classifier(s) to detect user input and/or distinguish between user input and non-user input. Customizer 206 may recognize one or more keys (e.g., key combinations) programmed to customize operation of TM 202 (e.g., for a particular application or user) for touch inputs detected by a touchscreen and/or touchpad. Customizer 204 may store customized settings, for example, in touch configuration 138. In some examples, customizer 206 may be combined with adapter 208, e.g., providing dynamic adaptation algorithms and a customization user interface to (e.g., directly or indirectly) touch profiles, feature weights, and/or classification thresholds.

Adapter 208 may be configured to adapt one or more parameters used by classifier(s) to distinguish between user input classes and/or non-user input classes. Adapter 208 may be configured to dynamically adjust one or more parameters, for example, to improve accuracy in differentiation of touch inputs and non-touch inputs. Adapter 208 may adjust profiling/classification parameters/characteristics, weights, and/or thresholds for the parameters/characteristics of classes, such as finger touch, palm touch, instrument touch, moisture touch, etc. Parameters/characteristics may include, for example, touch size, shape, duration, consistency, capacitance intensity, dynamics (e.g., shape change, movement pattern), clustering, palm indication, and/or other classification/differentiation parameter(s), such as difference (delta) thresholds between user input (e.g., finger touch, instrument touch) and non-user input (e.g., palm touch or moisture touch). Adjuster 208 may adjust parameters based on, for example, processing of detected touch inputs (e.g., differentiations between finger, palm, instrument, moisture touches), detected ambient environment (e.g., humidity, temperature), detected screen environment (e.g., moisture detection, temperature), etc. For example, when water droplets are detected (e.g., by classification based on the shape and associated features), adapter 208 and/or OS 130 may be made aware of the moisture touch. Reporting the location of the moisture interference to adapter 208 and/or OS 130 enables user interface modifications (e.g., temporarily blocking affected regions) and/or delivery of targeted user feedback.

Adapter 208 may store parameters (e.g., thresholds), for example, in touch configuration 138 for use by classifier(s) 214. In some examples, adapter 208 can be configured to monitor touch profiles to understand a user's interaction patterns. Adapter 208 can, based on the detected interaction patterns, dynamically adjust touch sensitivity to match the user's needs (e.g., provide increased sensitivity for users with detected limited mobility). In some examples, adapter 208 can sense the variations in a user's touch, identifying active and engaged touch points. In some examples, adapter 208 can adjust profiling characteristics and/or classification sensitivity for faster finger touches that may be associated with gaming interaction.

Data collector 210 may be configured to collect a dataset that includes one or more touch events. Data collector 210 may include one or more touch samplers. Data collector 210 may perform sampling of touch sensor array 106A, touch sensor array 120A, and/or other sources of data pertinent to touch profiling/classification. Data collector 210 may be scheduled to sample (e.g., periodic sampling) or may sample ad hoc (e.g., on demand). For example, data collector 210 may perform sampling periodically or based on detection of a change in capacitance on touch sensor array 106A and/or touch sensor array 120A. Data collector 210 may store each of a series of (e.g., periodically collected) datasets in TS storage device 110, TP storage device 124, and/or host storage device 128.

Feature extractor 212 may be configured to extract a set of features from the dataset collected by data collector 210. Feature extractor 212 may perform noise reduction by filtering out electrical noise in a dataset. Feature extractor 212 may be referred to as a featurizer. Feature extractor 212 may be configured to preprocess extracted data using a data preprocessor (e.g., data transformer, data normalizer) to transform and/or normalize data. Feature extractor 212 may process each dataset collected by data collector 210. Feature extractor 212 may be configured to extract a set of features utilized by classifier(s) 214 to classify touch events. For example, feature extractor 212 may be configured to extract one or more of the following features for each touch event in a dataset: touch size, shape, duration, consistency, capacitance intensity, dynamics (e.g., shape change, movement pattern), clustering, palm indication, etc. Feature extractor 212 may extract, for example, a BLOB representing a touch event and associate additional data with the BLOB so that classifier(s) 214 can classify the BLOB and associated data. The associated data may include or may reference multiple frames that show touch duration, consistency, movement, shape change, etc., which may be useful for classification/differentiation among classes. Feature extractor 212 may perform calculations to determine (e.g., extract) features, such as geometric profile and size, contact dynamics (e.g., movement patterns), touch duration and consistency, spatial distribution of touchpoints, etc.

Features that reference data over a time period/range support classification based on touch evolution over time. By monitoring how a touch shape changes (e.g., by tracking boundary irregularities and spread dynamics) in features, classifier(s) 214 can distinguish movement of a water droplet (e.g., that may be flattening or breaking up) from the relatively stable and predictable shape of a human finger touch or instrument touch. Static and dynamic features in the set of features allows classifier(s) 214 to identify complex non-linear relationships and subtle shape nuances that go beyond simple area or density metrics, which results in a more robust classification, particularly under varying environmental conditions where water droplet behavior can vary significantly. multi-dimensional feature extraction utilizing shape metrics with other features, such as capacitance intensity, contact dynamics, temporal characteristics, and spatial clustering, not only enhances the confidence of each classification decision, but also addresses cases where the shape alone might not be conclusive in a classification. The benefits are improved accuracy and a lower false-positive rate, making legitimate touches less likely to be rejected, even under challenging conditions where water droplets are present.

Classifier(s) 214 may be configured to classify each touch event based on the set of features extracted by feature extractor 212. Classifier(s) 214 may include one or more touch event/touchpoint classifiers. Classifier(s) 214 may be single-step or multi-step. For example, a single-step classifier may classify each detected touch event based on the associated set of features in a single step. A machine-learning (ML) model (e.g., ML model 164 executed by host processor 126, an NPU, TS TC 108, and/or TP TC 122) may perform such a single-step classification. In some examples, multiple sequenced classifiers 214 may classify touch events. In some examples, classifier(s) may generate classifications associated with probabilities (e.g., confidence levels). The classifications may function as intermediate classifications, which may be further analyzed in view of the probabilities and classification thresholds, which may be fixed, variable, adaptable, and/or customizable. In some examples, classifier(s) 214 may classify touch events as a class among the following set of classes: finger touch, palm touch, instrument/pen touch, moisture touch, moisture cluster (e.g., for multiple touch inputs/events), and/or palm cluster (e.g., for multiple touch inputs/events). Classifier(s) 214 may be trained machine-learning (ML) model(s). Classifier(s) 214 may be trained by trainer(s) 222 to classify feature sets indicating touch profiles for one or more touch events. A classifier among classifier(s) 214 may be selectable, for example, by OS 130 and/or user 140. For example, OS 130 may select different classifiers based on detected the environment of computing device 100. Further description of the training and implementation of ML models applicable to ML model 164 (FIG. 1) and other ML models referenced herein is provided with respect to ML model 728 of FIG. 7.

Determiner 216 may be configured to analyze classifications generated by classifier(s) 214, e.g., based on associated probabilities compared to one or more classification thresholds. For example, a default classification/confidence threshold may be 90% or 0.9. The threshold may be fixed or variable, e.g., based on environmental conditions. Adapter 208, e.g., if not disabled, may adjust the threshold based on detected environmental conditions, such as a first environment where moisture is detected on TS assembly 106 and/or TP assembly 120 and a second environment without moisture and low humidity. User 140 may customize the classification threshold(s) with fixed or variable thresholds, e.g., with indications of conditions to change customized threshold values.

Reporter 218 may be configured to report information to the host, e.g., OS 130, application(s) 134, or host processor 126. In some examples, reporter 218 may be configured to report touch BLOBs and associated data to OS 130 for classification (e.g., by classifier(s) 214 if/when executed by host processor 126). In some examples, reporter 218 may be configured to report touch BLOBs confirmed by classifier(s) 214 to be user input, which may avoid erroneous reports on non-user input and, thereby, conserve energy. In some examples, reporter 218 may be configured to (e.g., also) report moisture touch classifications to OS 130, e.g., if/when OS 130 is configured to react to moisture by adapting information displayed by OS 130 and/or application(s) 134 and/or by providing a notification (e.g., message) to user 140 about moisture detections, such as feedback 150.

Handler 220 may be configured to interpret and respond to the meaning of classified touch inputs. Handler 220 may be implemented, for example, by OS 130 and/or application(s) 134. Handler 220 may interpret the meaning (e.g., user intent) of user input based on the context of the OS 130 or application(s) 134 in which the user input was provided. The context may be based on the information displayed at the location of user input (e.g., finger touch 142, pen touch 154). For example, a user input may be determined to be a selection in a displayed menu or movement of a pointer. Handler 220 will effectuate the determined intent of the user input.

Handler 220 may be configured to provide feedback for user input (e.g., finger touch 142, pen touch 154) and/or non-user input (e.g., moisture touch 148). Feedback includes, for example, updating the information displayed on display panel 106B to reflect the most recent user touch event(s). Handler 220 may be configured to provide feedback at locations where user input was confirmed based on classification by classifier(s) 214 and confirmation by determiner 216. For example (e.g., as shown in FIG. 1), feedback 144 may be provided at locations where touch input was confirmed by classifier(s) 214 and determiner 216 to be user input (e.g., finger touch 142, pen touch 154). Feedback may be visual, haptic, etc. For example, a visual effect may be displayed by display panel 106B at the location of finger touch 142 and pen touch 154 to let the user know that the user input was detected. Handler 220 may (e.g., also) provide notification to a user and/or to OS 130 with respect to moisture classified touch events. Handler 220 may handle moisture touch classifications for OS 130, for example, if/when OS 130 is configured to react to moisture, e.g., by adapting information displayed by OS 130 and/or application(s) 134 and/or by providing a notification (e.g., message) to user 140 about moisture detections. For example, as shown in FIG. 1, handler 220 can provide a notification message, (e.g., please dry moisture . . . ) 150 for display by display panel 106B in the location of the moisture classified touch event on TS assembly 106 or at any location for moisture detected on TP assembly 120. The notification may textually indicate the location of the moisture or the notification may encircle or otherwise point to the moisture. This notification to the user of the location of moisture onscreen has advantages, including directing the user to avoid moisture laden areas that may no longer be accepting user input, and the encouragement to the user to remove the onscreen moisture to enable the full screen to again be useable for touch input.

Trainer(s) 222 may be configured to train classifier(s) 214 to classify touch event feature sets. Trainer(s) 222 may include one or more trainers for one or more classifiers 214. Trainer(s) 222 may be configured to train classifier(s) 214 using training data comprising labeled feature sets, e.g., labeled with the correct classification(s). Trainer(s) 222 may divide a labeled dataset as a training set and a testing set. The labeled dataset provides a target (e.g., a correct classification) for machine learning models to predict during training based on data of the input dataset, thereby enabling more efficient model training than with unlabeled training. The labeled dataset may be created based on empirical examples collected during actual or simulated use of computing device 100 or a similar computing device in a variety of environments.

FIG. 3 shows an example of a touch device 300 configured for touch profile-based clustering of fragmented touch inputs, according to an example embodiment. Touch device 300 is a device configured to receive input in the form of user touch (e.g., by finger, stylus, etc.) and is an example of touch devices 160 and 162 in FIG. 1. As shown in FIG. 3, touch device 300 includes a touch sensor array 304. In embodiments, touch device 300 may include further features not shown in FIG. 3 (e.g., a touch surface, a display panel (e.g., an array of light emitting diodes)). Touch device 300 is configured to perform touch profile-based clustering of fragmented touch inputs with multiple touch events. As shown in FIG. 3, touch sensor array 304 detects multiple touchpoints in a first cluster 306 (e.g., touchpoints 310A-310D) and in a second cluster 308 (e.g., touchpoints 312A-312D). These fragmented user inputs (e.g., moisture and palm touchpoints) that may otherwise be determined to be independent touchpoints (e.g., without touch profiling and classification) can be merged based on touch profile uniformity. Fragmented inputs that are user input may be classified as user input (e.g., finger touch, pen touch) while fragmented inputs that are non-user input (e.g., moisture or palm touch/contact points) may be classified as non-touch inputs. For example, as shown in FIG. 3, classifier(s) 214 may merge fragmented moisture inputs 306 and/or fragmented palm inputs 308 based on touch profile-clustering (e.g., touch profile uniformity) of the touch feature sets associated with each touch event/touchpoint. The touch profile uniformity is based on interpretation of multiple touch events as having a common source (e.g., moisture, palm), which may avoid misclassification, misinterpretation, and conserve resources (e.g., power/battery life, processing time, memory).

Touch profile-based clustering may occur, for example, in classifier(s) 214, e.g., prior to interpretation of classified user input touchpoints by handler 220, which may conserve energy and processing time. For example, classifier(s) 214 may be configured to classify a plurality of fragmented touch inputs based on touch profile-based clustering (e.g., touch profile uniformity) of a plurality of fragmented touch inputs or based on a touch profile differential comparing current touchpoint profiles to profiles of past or present touchpoint profiles, e.g., with the differential exceeding a threshold differential.

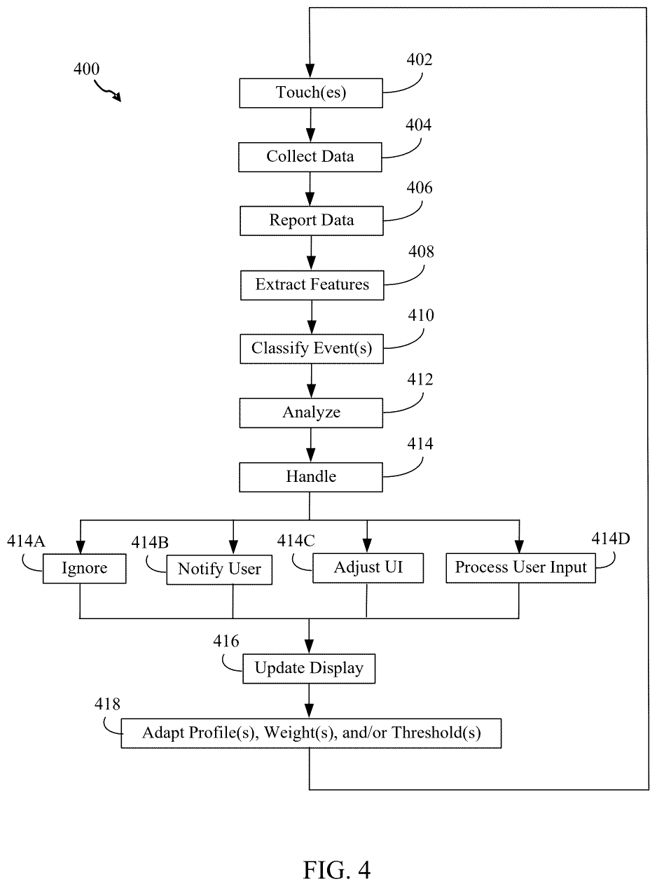

Embodiments disclosed herein may operate in various ways. For instance, FIG. 4 shows a flowchart 400 of providing a touch profiling and classification interface, in accordance with an embodiment. Embodiments disclosed herein and other embodiments may operate in accordance with examples shown in FIGS. 1-3. Example flowchart 400 shows an example method of providing a touch profiling and classification interface implemented by touchscreen assembly 106 (e.g., touch sensor array 106A/304, display panel 106B), touchpad assembly 120 (e.g., touch sensor array 120A/304), TS TC 108, TP TC 122, TM 136/202, etc. Flowchart 400 comprises steps 402-418. However, other embodiments may operate according to other methods, such as described with respect to FIG. 4. Other structural and operational embodiments will be apparent to persons skilled in the relevant art(s) based on the foregoing discussion of embodiments. No order of steps is required unless expressly indicated or inherently required. There is no requirement that a method embodiment implement all of the steps illustrated in FIG. 4. FIG. 4 is simply one of many possible embodiments. Embodiments may implement fewer, more or different steps.

As shown in FIG. 4, flowchart 400 includes a loop, which may repeat periodically, e.g., based on a touch interface processing rate and/or other factors. As shown in example flowchart 400, at step 402, one or more touches occur. For example, as shown in FIG. 1, user 140 interacts with TS assembly 106 and/or TP assembly 120, such as finger touch 142, palm touch 146, instrument touch 154, and/or moisture touch(es) 148 occur, resulting in one or more touch events located at one or more touchpoints.

At step 404, data is collected for the one or more touches. For example, as shown in FIGS. 1 and 2, data collector 210 collects a dataset including data indicating the one or more touch events.

At step 406, the dataset(s) is(are) reported. For example, as shown in FIGS. 1 and 2, reporter 218 executed by TS TC 108 or TP TC 122 reports a BLOB and associated data for each touch event to host processor 126/OS 130.

At step 408, features are extracted. For example, as shown in FIGS. 1 and 2, feature extractor 212 executed by host processor 126 extracts a set of features representing each touch event from the dataset.

At step 410, the one or more touch events are classified. For example, as shown in FIGS. 1 and 2, trained classifier(s) 214 executed by host processor 126 classify each touch event based on the touch profile presented by the set of features representing the touch event. Classifier(s) 214 may classify the touch events individually or collectively, e.g., considering multiple present and past touch events as a context for classification of individual touch events.

At step 412, the classifications are analyzed. For example, as shown in FIGS. 1 and 2, determiner 216 analyzes each classified touch event in view of one or more classification thresholds. Determiner 216 may analyze the touch events individually or collectively, e.g., considering multiple present and past touch events as a context during analysis of individual touch events. Determiner 216 outputs a final classification for each touch event.

At step 414, the classified touch events are handled. For example, as shown in FIGS. 1 and 2, handler 220 determines what action, if any, to take for each classified touch event. Several examples are provided, but the examples are not exclusive. As shown in FIG. 4, handler 220 may ignore a classified touch event 414A, notify a user about the touch event 414B, adjust a user interface (UI) for a touch event 414C, and/or process user input 414D. For example, handler 220 may be configured to ignore 414A a touch event classified as palm touch(es) 146. Handler 220 may be configured to notify a user 414B about a touch event classified as moisture touch(es) 148. Handler 220 may be configured to adjust (e.g., relocate) a UI 414C, e.g., for OS 130 and/or application(s) 134 to counteract (e.g., avoid) showing a user interface in a location of TS assembly 106 where a touch event was classified as moisture touch(es) 148. Handler 220 may be configured to process a touch event 414D classified as finger touch 142 or pen touch 156, e.g., by implementing the user intent determined for the touch event.

At step 416, the display is updated. For example, as shown in FIGS. 1 and 2, OS 130 and/or application(s) 134 update information displayed by display panel 106B to reflect the handling of the touch event(s). For example, the information displayed by display panel 106B may remain the same as previously displayed, may reflect relocation of a UI away from moisture, may provide a notice about moisture, and/or may reflect implementation of user input (e.g., menu selection, cursor movement).

At step 418, thresholds and/or weights may be updated. For example, as shown in FIGS. 1 and 2, adapter 208 (e.g., if enabled) may or may not use currently known information about the touch interfaces and/or ambient environment to change one or more touch profile feature weights for classification and/or final classification thresholds, e.g., to adapt touch profiling and/or classification to prevailing conditions for improved touch performance.

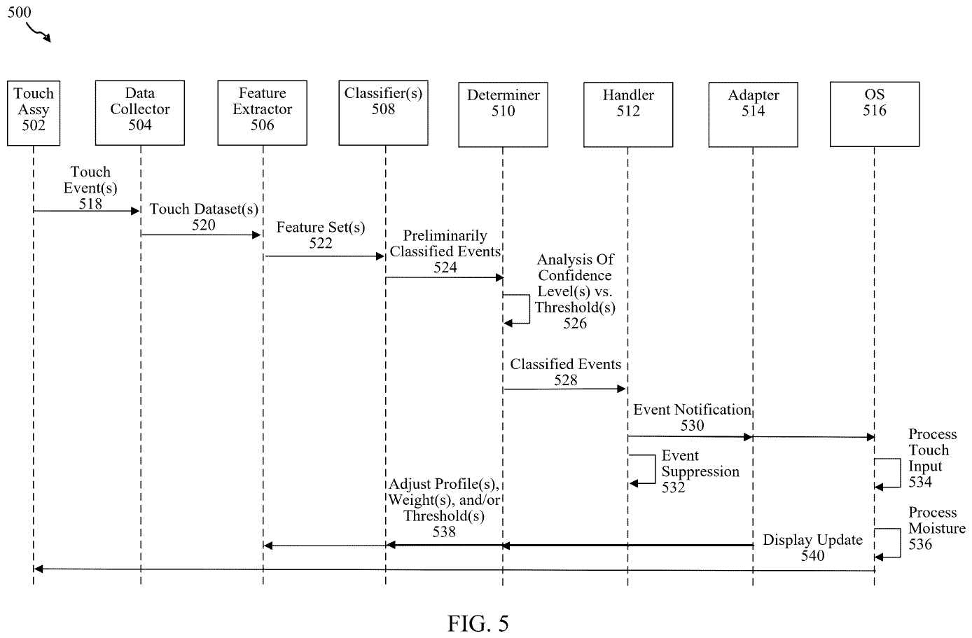

FIG. 5 shows an example interaction diagram 500 for a touch profiling and classification interface, in accordance with an example embodiment. Example interactions are shown between a touch assembly (assy) 502, a data collector 504, a feature extractor 506, one or more classifiers 508, a determiner 510, a handler 512, an adapter 514, and an OS 516. Components in FIG. 5 correspond to similarly named components in FIGS. 1-4 and thus may be similarly implemented in a computing device. Example interaction diagram 500 comprises operations or steps 518 to 540, which may repeat (e.g., periodically) in part or in whole. However, other embodiments may operate according to other interaction diagrams. Other structural and operational embodiments will be apparent to persons skilled in the relevant art(s) based on the foregoing discussion of embodiments. No order of steps is required unless expressly indicated or inherently required. There is no requirement that an interaction diagram embodiment implement all of the steps illustrated in FIG. 5. FIG. 5 is simply one of many possible embodiments. Embodiments may implement fewer, more or different steps.

As shown in example interaction diagram 500, at interaction 518, one or more touch events at a touch assembly 502 result in data collection by data collector 504 from touch assembly 502. For example, as shown in FIG. 1, user 140 interacts with TS assembly 106 and/or TP assembly 120 (e.g., resulting in finger touch 142, palm touch 146, instrument touch 154) and/or moisture touch(es) 148 occur. The one or more touch events located at one or more touchpoints result in data generation by touch sensors in touch sensor array 106A and/or touch sensor array 120A. The data is collected by data collector 504.

At interaction 520, data collected for the one or more touches is provided as touch dataset(s) by data collector 504 to feature extractor 506. For example, as shown in FIGS. 1 and 2, data collector 210 collects one or more datasets that include data indicating the one or more touch events and provides the touch dataset(s) to feature extractor 212.

At interaction 522, feature extractor 506 provides feature set(s) extracted from the dataset(s) to classifier(s) 508. For example, as shown in FIGS. 1 and 2, feature extractor 212 extracts a set of features representing each touch event from the dataset(s) and provides the feature set(s) to classifier(s) 214.

At interaction 524, classifier(s) 508 provides preliminarily classified events to determiner 510. For example, as shown in FIGS. 1 and 2, trained classifier(s) 214 classify each touch event based on the touch profile presented by the set of features representing the touch event. Classifier(s) 214 may classify the touch events individually or collectively, e.g., considering multiple present and past touch events as a context for classification of individual touch events. Classifier(s) 214 provide the preliminary classifications to determiner 216 for analysis.

At action 526, the determiner 510 analyzes the preliminary classifications by comparing the confidence level associated with each preliminary classification to a classification threshold. For example, as shown in FIGS. 1 and 2, determiner 216 analyzes each classified touch event in view of one or more classification thresholds. Determiner 216 may analyze the touch events individually or collectively, e.g., considering multiple present and past touch events as a context during analysis of individual touch events. Determiner 216 outputs a final classification for each touch event.

At interaction 528, determiner 510 provides classified events to handler 512. For example, as shown in FIGS. 1 and 2, determiner 216 provides classified events to handler 220.

At interaction 530, the classified touch events are handled by providing event notification to adapter 514 and OS 516. For example, as shown in FIGS. 1 and 2, handler 220 determines whether to provide classified events to adapter 208 and OS 130 or suppress the classified events. It may be observed that this example presents a more limited role for handler 220 than a previous example. In this example, handler 220 may decide (e.g., based on a configuration) whether or not to report a classified event to OS 130 and adapter 208. Handler 220 may be configured to report only user input, or user input and moisture input, or all user input and all non-user input, and so on. If a classified event is to be reported, reporter 218 (not shown in FIG. 5) may perform the reporting of the classified event to adapter 208 and OS 130. For example, handler 220 may be configured to report user input touch events (e.g., finger touch 142 and pen touch 154) and non-user input moisture touch(es) 148 to adapter 208 and OS 130.

In some examples, customizer 206 is combined with adapter 208. As shown in FIGS. 1 and 2, user 140 interacts with a user interface provided by adapter 208 to indicate user settings (e.g., configure operating parameters) for the touchpad and/or touchscreen touch-sensing touch interface to improve differentiation of touch inputs and non-touch inputs. Adapter 208 may use user customization alone or in combination with dynamic adaptations determined by adapter 208 (e.g., based on event notifications) to adjust one or more of the following: a touch detection sensitivity threshold, a touch profile, a feature weight, and/or a classification threshold.

At action 532, handler 512 may perform event suppression. For example, as shown in FIGS. 1 and 2, handler 220 may be configured to suppress (e.g., ignore) palm touch(es) 146, e.g., by not forwarding touch events classified as palm touches to adapter 208 and OS 130.

At interaction 534, OS 516 processes touch input. For example, as shown in FIG. 1, OS 130 may interpret user intent and perform the action(s) representing user intent. OS 130 determines what action, if any, to take for each classified touch event. OS 130 may perform all actions and/or may engage with application(s) 134 to perform one or more actions, for example, depending on the context in which user 140 entered the user input (e.g., finger touch 142 and/or instrument touch 154), such as selection of a menu item in a GUI presented by OS 130 or application(s) 134, moved a cursor in a window or between windows, etc. One of the actions would be to update the information displayed by display panel 106B to reflect implementation of user input (e.g., menu selection, cursor movement).

At interaction 536, OS 516 processes a touch event classified as moisture. For example, as shown in FIG. 1, OS 130 may be configured to be aware of and/or to take one or more actions in response to moisture detections. For example, OS 130 may be configured to notify user 140 about moisture touch(es) 148. OS 130 may be configured to counteract/take evasive action by adjusting or relocating a user interface (e.g., window) on behalf of OS 130 and/or application(s) 134 to counteract (e.g., avoid) showing a user interface in a location of TS assembly 106 where a touch event was classified as moisture touch(es) 148.

At interaction 538, adapter 514 updates, if at all, profile(s), weight(s), and/or threshold(s). For example, as shown in FIGS. 1 and 2, adapter 208 (e.g., if enabled) may or may not use currently known information about the touch interfaces and/or ambient environment, such as event notifications received from handler 512, to change one or more touch profiles, feature weights for classification, and/or final classification thresholds, e.g., to adapt feature extraction, touch profiling, and/or classification to prevailing conditions for improved touch performance.

At interaction 540, OS 516 updates the display of touch assembly 502. For example, as shown in FIGS. 1 and 2, OS 130 and/or application(s) 134 update information displayed by display panel 106B to reflect the handling of a user input touch event processed at 534 and/or a non-user input moisture event processed at 536. For example, the information displayed by display panel 106B may be updated to reflect implementation of user input (e.g., menu selection, cursor movement). For example, the information displayed by display panel 106B may be updated to reflect relocation of a UI away from detected moisture and/or to present a notification (e.g., feedback 150) about moisture detected on TS assembly 106 and/or TP assembly 120.

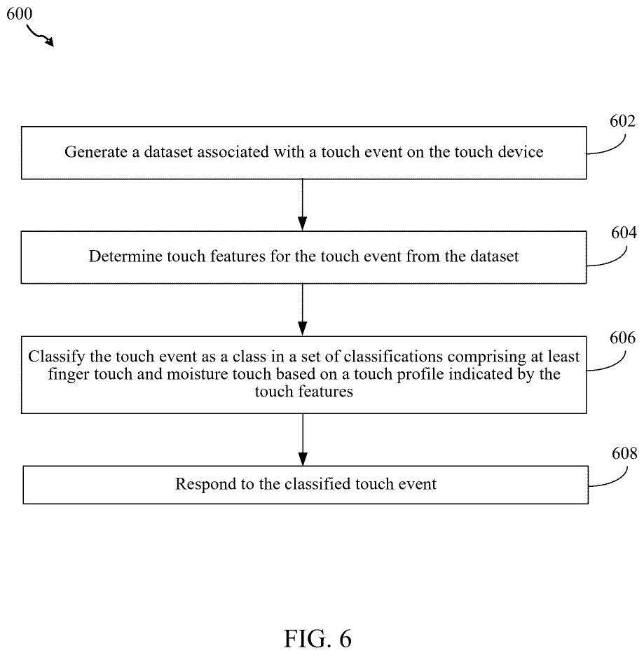

FIG. 6 shows a flowchart 600 of a process for providing a touch profiling and classification interface, in accordance with an embodiment. Embodiments disclosed herein and other embodiments may operate in accordance with examples shown in FIGS. 1-5. Flowchart 600 shows an example method of providing a touch-sensing touch interface executed by touchscreen assembly 106 (e.g., touch sensor array 106A, display panel 106B), touchpad assembly 120 (e.g., touch sensor array 120A), TS TC 108, TP TC 122, TM 136/202, etc. The example shown in FIG. 6 includes operations 602-608. There is no requirement that a method embodiment implement all of the steps illustrated in FIG. 6. FIG. 6 is simply one of many possible embodiments. Various embodiments may implement one or more operations shown in FIG. 6 with additional and/or alternative steps. Further structural and operational embodiments will be apparent to persons skilled in the relevant art(s) based on the following description of FIG. 6.

As shown in example flowchart 600, at step 602, a dataset associated with a touch event on the touch device is generated. For example, as shown in FIGS. 1 and 2, data collector 210 generates a dataset from data generated by touch sensor array 106A and/or touch sensor array 120A. The data in the dataset may be raw data and/or processed data created from raw data.

In step 604, touch features for the touch event are determined from the dataset. For example, as shown in FIGS. 1 and 2, feature extractor 212 extracts a set of features from the dataset that characterize each touch event in the dataset.

In step 606, the touch event is classified as a class in a set of classifications comprising at least finger touch and moisture touch based on a touch profile indicated by the touch features. For example, as shown in FIGS. 1 and 2, classifier(s) 214 classifies each touch event represented in the set of features.

In step 608, the classified touch event is responded to. For example, as shown in FIGS. 1 and 2, TM 136, OS 130, and/or application(s) 134 may be configured to interpret the meaning of user input (e.g., finger touch 142, pen touch 154) and respond to the user input. For example, TM 136, OS 130, and/or application(s) 134 may determine that user 140 intended to select an item in a menu. TM 136, OS 130, and/or application(s) 134 may respond to the interpreted meaning by selecting the item in the menu. Further, TM 136, OS 130, and/or application(s) 134 may be configured to respond to touch events classified as moisture input. For example, TM 136, OS 130, and/or application(s) 134 may be configured to generate user feedback, such as feedback 150.

### III. Example Computing Device Embodiments

In embodiments, one or more of TS TC 108, TP TC 122, TM 136/202, OS 130/516, application(s) 134, interface 204, customizer 206, adapter 208/514, data collector 210/504, feature extractor 212/506, classifier(s) 214/508, determiner 216/510, reporter 218, handler 220/512, trainer(s) 222, components of interaction diagram 500, and flowcharts 400 and 600 is/are implemented with computer program code/instructions configured to be executed in one or more processors and stored in a computer readable storage medium. Additionally or alternatively, one or more of TS TC 108, TP TC 122, TM 136/202, OS 130/516, application(s) 134, interface 204, customizer 206, adapter 208/514, data collector 210/504, feature extractor 212/506, classifier(s) 214/508, determiner 216/510, reporter 218, handler 220/512, trainer(s) 222, components of interaction diagram 500, and flowcharts 400 and 600 are implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions. In still further embodiments, one or more of TS TC 108, TP TC 122, TM 136/202, OS 130/516, application(s) 134, interface 204, customizer 206, adapter 208/514, data collector 210/504, feature extractor 212/506, classifier(s) 214/508, determiner 216/510, reporter 218, handler 220/512, trainer(s) 222, components of interaction diagram 500, and flowcharts 400 and 600 are implemented in further forms of electrical circuitry, including logic gates, transistors, operational amplifiers, field programmable gate arrays (FPGAs), etc.

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 7. FIG. 7 shows a block diagram of an exemplary computing environment 700 that includes a computing device 702. Computing device 702 is an example of computing device 100, which may include one or more of the components of computing device 702. In some embodiments, computing device 702 is communicatively coupled with devices (not shown in FIG. 7) external to computing environment 700 via network 704. Network 704 comprises one or more networks such as local area networks (LANs), wide area networks (WANs), enterprise networks, the Internet, etc. In examples, network 704 includes one or more wired and/or wireless portions. In some examples, network 704 additionally or alternatively includes a cellular network for cellular communications. Computing device 702 is described in detail as follows.

Computing device 702 is any of a variety of types of computing devices. Examples of computing device 702 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 702 is a stationary computing device such as a desktop computer, a personal computer (PC), a stationary server device, a minicomputer, a mainframe, a supercomputer, etc.

As shown in FIG. 7, computing device 702 includes a variety of hardware and software components, including a processor 710, a storage 720, a graphics processing unit (GPU) 742, a neural processing unit (NPU) 744, one or more input devices 730, one or more output devices 750, one or more wireless modems 760, one or more wired interfaces 780, a power supply 782, a location information (LI) receiver 784, and an accelerometer 786. Storage 720 includes memory 756, which includes non-removable memory 722 and removable memory 724, and a storage device 788. Storage 720 also stores an operating system 712, application programs 714, and application data 716. Wireless modem(s) 760 include a Wi-Fi modem 762, a Bluetooth modem 764, and a cellular modem 766. Output device(s) 750 includes a speaker 752 and a display 754. Input device(s) 730 includes a touch screen 732, a microphone 734, a camera 736, a physical keyboard 738, and a trackball 740. Not all components of computing device 702 shown in FIG. 7 are present in all embodiments, additional components not shown may be present, and in a particular embodiment any combination of the components are present. In examples, components of computing device 702 are mounted to a circuit card (e.g., a motherboard) of computing device 702, integrated in a housing of computing device 702, or otherwise included in computing device 702. The components of computing device 702 are described as follows.

In embodiments, a single processor 710 (e.g., central processing unit (CPU), microcontroller, a microprocessor, signal processor, ASIC (application specific integrated circuit), and/or other physical hardware processor circuit) or multiple processors 710 are present in computing device 702 for performing such tasks as program execution, signal coding, data processing, input/output processing, power control, and/or other functions. In examples, processor 710 is a single-core or multi-core processor, and each processor core is single-threaded or multithreaded (to provide multiple threads of execution concurrently). Processor 710 is configured to execute program code stored in a computer readable medium, such as program code of operating system 712 and application programs 714 stored in storage 720. The program code is structured to cause processor 710 to perform operations, including the processes/methods disclosed herein. Operating system 712 controls the allocation and usage of the components of computing device 702 and provides support for one or more application programs 714 (also referred to as “applications” or “apps”). In examples, application programs 714 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 710 includes one or more general processors (e.g., CPUs) configured with or coupled to one or more hardware accelerators, such as one or more NPUs 744 and/or one or more GPUs 742.

Any component in computing device 702 can communicate with any other component according to function, although not all connections are shown for ease of illustration. For instance, as shown in FIG. 7, bus 706 is a multiple signal line communication medium (e.g., conductive traces in silicon, metal traces along a motherboard, wires, etc.) present to communicatively couple processor 710 to various other components of computing device 702, although in other embodiments, an alternative bus, further buses, and/or one or more individual signal lines is/are present to communicatively couple components. Bus 706 represents one or more of any of several types of bus structures, including a memory bus or memory controller, a peripheral bus, an accelerated graphics port, and a processor or local bus using any of a variety of bus architectures.

Storage 720 is physical storage that includes one or both of memory 756 and storage device 788, which store operating system 712, application programs 714, and application data 716 according to any distribution. Non-removable memory 722 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 722 includes main memory and is separate from or fabricated in a same integrated circuit as processor 710. As shown in FIG. 7, non-removable memory 722 stores firmware 718 that is present to provide low-level control of hardware. Examples of firmware 718 include BIOS (Basic Input/Output System, such as on personal computers) and boot firmware (e.g., on smart phones). In examples, removable memory 724 is inserted into a receptacle of or is otherwise coupled to computing device 702 and can be removed by a user from computing device 702. Removable memory 724 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 788 are present that are internal and/or external to a housing of computing device 702 and are or are not removable. Examples of storage device 788 include a hard disk drive, a SSD, a thumb drive (e.g., a USB (Universal Serial Bus) flash drive), or other physical storage device.

One or more programs are stored in storage 720. Such programs include operating system 712, one or more application programs 714, and other program modules and program data. Examples of such application programs include computer program logic (e.g., computer program code/instructions) for implementing one or more of TS TC 108, TP TC 122, TM 136/202, OS 130/516, application(s) 134, touch configuration 138, interface 204, customizer 206, adapter 208/514, data collector 210/504, feature extractor 212/506, classifier(s) 214/508, determiner 216/510, reporter 218, handler 220/512, trainer(s) 222, components of interaction diagram 500, and flowcharts 400 and 600 (and/or any individual operations/steps thereof).

Storage 720 also stores data used and/or generated by operating system 712 and application programs 714 as application data 716. Examples of application data 716 include web pages, text, images, tables, sound files, video data, and other data. In examples, application data 716 is sent to and/or received from one or more network servers or other devices via one or more wired or wireless networks. Storage 720 is used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 702 through one or more input devices 730 and receives information from computing device 702 through one or more output devices 750. Input device(s) 730 includes one or more of touch screen 732, microphone 734, camera 736, physical keyboard 738, and/or trackball 740 and output device(s) 750 includes one or more of speaker 752 and display 754. Each of input device(s) 730 and output device(s) 750 are integral to computing device 702 (e.g., built into a housing of computing device 702) or are external to computing device 702 (e.g., communicatively coupled wired or wirelessly to computing device 702 via wired interface(s) 780 and/or wireless modem(s) 760). Further input devices 730 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 754 displays information, as well as operating as touch screen 732 by receiving user commands and/or other information (e.g., by touch, finger gestures, virtual keyboard, etc.) as a user interface. Any number of each type of input device(s) 730 and output device(s) 750 are present, including multiple microphones 734, multiple cameras 736, multiple speakers 752, and/or multiple displays 754.

In embodiments where GPU 742 is present, GPU 742 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 742 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 744 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 728. In an example, NPU 744 is configured for a data-driven parallel computing and is highly efficient at processing massive multimedia data such as videos and images and processing data for neural networks. NPU 744 is configured for efficient handling of AI-related tasks, such as speech recognition, background blurring in video calls, photo or video editing processes like object detection, etc.

In embodiments disclosed herein that implement ML models, NPU 744 can be utilized to execute such ML models, of which MLM 728 is an example. For instance, where applicable, MLM 728 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 744 is used to train MLM 728. To train MLM 728, training data is that includes input features (attributes) and their corresponding output labels/target values (e.g., for supervised learning) is collected. A training algorithm is a computational procedure that is used so that MLM 728 learns from the training data. Examples of training inputs for ML model training include user position, angle, gesture, time of day, location, user crypto, etc. Parameters/weights are internal settings of MLM 728 that are adjusted during training by the training algorithm to reduce a difference between predictions by MLM 728 and actual outcomes (e.g., output labels). In some examples, MLM 728 is set with initial values for the parameters/weights. A loss function measures a dissimilarity between predictions by MLM 728 and the target values, and the parameters/weights of MLM 728 are adjusted to minimize the loss function. The parameters/weights are iteratively adjusted by an optimization technique, such as gradient descent. In this manner, MLM 728 is generated through training by NPU 744 to be used to generate inferences based on received input feature sets for particular applications. MLM 728 is generated as a computer program or other type of algorithm configured to generate an output (e.g., a classification, a prediction/inference) based on received input features and is stored in the form of a file or other data structure.

In examples, such training of MLM 728 by NPU 744 is supervised or unsupervised. According to supervised learning, input objects (e.g., a vector of predictor variables) and a desired output value (e.g., a human-labeled supervisory signal) train MLM 728. The training data is processed, building a function that maps new data on expected output values. Example algorithms usable by NPU 744 to perform supervised training of MLM 728 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 728 is an LLM, MLM 728 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user's ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 728 is trained to learn patterns from unlabeled data. For instance, in embodiments where MLM 728 implements unsupervised learning techniques, MLM 728 identifies one or more classifications or clusters to which an input belongs. During a training phase of MLM 728 according to unsupervised learning, MLM 728 tries to mimic the provided training data and uses the error in its mimicked output to correct itself (i.e., correct weights and biases). In further examples, NPU 744 perform unsupervised training of MLM 728 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 744 need not necessarily be present in all ML model embodiments. In embodiments where ML models are present, any one or more of processor 710, GPU 742, and/or NPU 744 can be present to train and/or execute MLM 728.

One or more wireless modems 760 can be coupled to antenna(s) (not shown) of computing device 702 and can support two-way communications between processor 710 and devices external to computing device 702 through network 704, as would be understood to persons skilled in the relevant art(s). Wireless modem 760 is shown generically and can include a cellular modem 766 for communicating with one or more cellular networks, such as a GSM network for data and voice communications within a single cellular network, between cellular networks, or between the mobile device and a public switched telephone network (PSTN). In examples, wireless modem 760 also or alternatively includes other radio-based modem types, such as a Bluetooth modem 764 (also referred to as a “Bluetooth device”) and/or Wi-Fi modem 762 (also referred to as an “wireless adaptor”). Wi-Fi modem 762 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 764 is configured to communicate with another Bluetooth-capable device according to the Bluetooth short-range wireless technology standard(s) such as IEEE 802.15.1 and/or managed by the Bluetooth Special Interest Group (SIG).

Computing device 702 can further include power supply 782, LI receiver 784, accelerometer 786, and/or one or more wired interfaces 780. Example wired interfaces 780 include a USB port, IEEE 1394 (Fire Wire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 780 of computing device 702 provide for wired connections between computing device 702 and network 704, or between computing device 702 and one or more devices/peripherals when such devices/peripherals are external to computing device 702 (e.g., a pointing device, display 754, speaker 752, camera 736, physical keyboard 738, etc.). Power supply 782 is configured to supply power to each of the components of computing device 702 and receives power from a battery internal to computing device 702, and/or from a power cord plugged into a power port of computing device 702 (e.g., a USB port, an A/C power port). LI receiver 784 is useable for location determination of computing device 702 and in examples includes a satellite navigation receiver such as a Global Positioning System (GPS) receiver and/or includes other type of location determiner configured to determine location of computing device 702 based on received information (e.g., using cell tower triangulation, etc.). Accelerometer 786, when present, is configured to determine an orientation of computing device 702.

Note that the illustrated components of computing device 702 are not required or all-inclusive, and fewer or greater numbers of components can be present as would be recognized by one skilled in the art. In examples, computing device 702 includes one or more of a gyroscope, barometer, proximity sensor, ambient light sensor, digital compass, etc. In an example, processor 710 and memory 756 are co-located in a same semiconductor device package, such as being included together in an integrated circuit chip, FPGA, or system-on-chip (SOC), optionally along with further components of computing device 702.

In embodiments, computing device 702 is configured to implement any of the above-described features of flowcharts herein. Computer program logic for performing any of the operations, steps, and/or functions described herein is stored in storage 720 and executed by processor 710.

In some embodiments, server infrastructure 770 is present in computing environment 700 and is communicatively coupled with computing device 702 via network 704. Server infrastructure 770, when present, is a network-accessible server set (e.g., a cloud-based environment or platform). As shown in FIG. 7, server infrastructure 770 includes clusters 772. Each of clusters 772 comprises a group of one or more compute nodes and/or a group of one or more storage nodes. For example, as shown in FIG. 7, cluster 772 includes nodes 774. Each of nodes 774 are accessible via network 704 (e.g., in a “cloud-based” embodiment) to build, deploy, and manage applications and services. In examples, any of nodes 774 is a storage node that comprises a plurality of physical storage disks, SSDs, and/or other physical storage devices that are accessible via network 704 and are configured to store data associated with the applications and services managed by nodes 774.

Each of nodes 774, as a compute node, comprises one or more server computers, server systems, and/or computing devices. For instance, a node 774 in accordance with an embodiment includes one or more of the components of computing device 702 disclosed herein. Each of nodes 774 is configured to execute one or more software applications (or “applications”) and/or services and/or manage hardware resources (e.g., processors, memory, etc.), which are utilized by users (e.g., customers) of the network-accessible server set. In examples, as shown in FIG. 7, nodes 774 includes a node 746 that includes storage 748 and/or one or more of a processor 758 (e.g., similar to processor 710, GPU 742, and/or NPU 744 of computing device 702). Storage 748 stores application programs 776 and application data 778. Processor(s) 758 operates application programs 776 which access and/or generate related application data 778. In an implementation, nodes such as node 746 of nodes 774 operate or comprise one or more virtual machines, with each virtual machine emulating a system architecture (e.g., an operating system), in an isolated manner, upon which applications such as application programs 776 are executed.

In embodiments, one or more of clusters 772 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 772 are included in a datacenter in a distributed collection of datacenters. In embodiments, exemplary computing environment 700 comprises part of a cloud-based platform.

In an embodiment, computing device 702 accesses application programs 776 for execution in any manner, such as by a client application and/or a browser at computing device 702.

In an example, for purposes of network (e.g., cloud) backup and data security, computing device 702 additionally and/or alternatively synchronizes copies of application programs 714 and/or application data 716 to be stored at network-based server infrastructure 770 as application programs 776 and/or application data 778. In examples, operating system 712 and/or application programs 714 include a file hosting service client configured to synchronize applications and/or data stored in storage 720 at network-based server infrastructure 770.

In some embodiments, on-premises servers 792 are present in computing environment 700 and are communicatively coupled with computing device 702 via network 704. On-premises servers 792, when present, are hosted within an organization's infrastructure and, in many cases, physically onsite of a facility of that organization. On-premises servers 792 are controlled, administered, and maintained by IT (Information Technology) personnel of the organization or an IT partner to the organization. Application data 798 can be shared by on-premises servers 792 between computing devices of the organization, including computing device 702 (when part of an organization) through a local network of the organization, and/or through further networks accessible to the organization (including the Internet). Furthermore, in examples, on-premises servers 792 serve applications such as application programs 796 to the computing devices of the organization, including computing device 702. Accordingly, in examples, on-premises servers 792 include storage 794 (which includes one or more physical storage devices such as storage disks and/or SSDs) for storage of application programs 796 and application data 798 and include a processor 790 (e.g., similar to processor 710, GPU 742, and/or NPU 744 of computing device 702) for execution of application programs 796. In some embodiments, multiple processors 790 are present for execution of application programs 796 and/or for other purposes. In further examples, computing device 702 is configured to synchronize copies of application programs 714 and/or application data 716 for backup storage at on-premises servers 792 as application programs 796 and/or application data 798.

Embodiments described herein may be implemented in one or more of computing device 702, network-based server infrastructure 770, and on-premises servers 792. For example, in some embodiments, computing device 702 is used to implement systems, clients, or devices, or components/subcomponents thereof, disclosed elsewhere herein. In other embodiments, a combination of computing device 702, network-based server infrastructure 770, and/or on-premises servers 792 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 720. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules, or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 714) are stored in storage 720. Such computer programs can also be received via wired interface(s) 760 and/or wireless modem(s) 760 over network 704. Such computer programs, when executed or loaded by an application, enable computing device 702 to implement features of embodiments discussed herein. Accordingly, such computer programs represent controllers of the computing device 702.

Embodiments are also directed to computer program products comprising computer code or instructions stored on any computer-readable medium or computer-readable storage medium. Such computer program products include the physical storage of storage 720 as well as further physical storage types.

### IV. Additional Example Embodiments

Embodiments described herein describe touch type profiling and classification for a capacitive touch interface. A capacitive touch interface with touch type profiling and classification improves accuracy in classifying touch events, allowing users to interact with touch devices (e.g., touchscreens and touchpads) more naturally. Resources are conserved by avoiding reporting, processing, actions and reversals for non-input touch events. Touch features are extracted from a touch event dataset, e.g., touch location, size, shape, duration, consistency, capacitance intensity, dynamics (e.g., shape change, movement pattern), clustering, palm indication, etc. Touch events are classified (e.g., as touch input, instrument input, palm touch, moisture) based on touch profiles indicated by touch features. Moisture touches and palm touches can be classified as non-input, even when appearing as fragmented touches resembling finger touches, by profiling and classifying touch types based on touch characteristics. For example, a moisture profile can include irregular touch shapes, weak or inconsistent capacitance measurements, and/or an abnormal contact dynamic. Feedback can be provided at touchpoints classified as input and/or non-input. Different feedback can be provided for different classes, such as a moisture indication to the user and/or to the operating system to remove or counteract moisture. Users can customize touch type profiles and/or touch type sensitivities for touch type classifications. Dynamic adaptations are provided during touch input, such as touch profiling adaptations and/or touch sensitivity adaptations based on touch type detections/classifications and/or based on detected screen and/or ambient environmental conditions.

Computing systems are described herein. In an aspect, a computing device comprises a touch device (e.g., touchscreen and/or touchpad). The device includes a data collector configured to generate a dataset associated with a touch event on the touch device. The dataset can be generated by a touch sensor array. Each touch event can be associated with at least one touchpoint on the capacitive touch device. The touchpoint(s) may or may not be user input. The device includes a feature extractor configured to determine touch features (e.g., touch characteristics/parameters) from the dataset. Touch features include, for example, touch location, touch size, touch shape, touch duration, touch consistency, capacitance intensity, touch dynamics (e.g., shape change, movement pattern), touch clustering, palm indication, etc. The various touch features correspond to different touch types (e.g., finger, palm, moisture), and thus can be used to predict what kind of touch has occurred. For instance, one or more of small size, relatively round shape, a short duration, etc., may correlate to a finger touch. A larger size, a relatively oval shape, a medium duration, etc., may correlate to a palm touch. Abstract shapes, a long duration, tightly clustered shapes, etc., may correlate to moisture touch. The device includes a classifier configured to classify the touch event as a class in a set of classifications comprising at least user input and moisture input based on a touch profile indicated by the touch features. For example, a moisture touch profile can include irregular touch shapes, weak or inconsistent capacitance measurements, and/or an abnormal contact dynamic. The device includes a handler to respond to the classified touch events. The handler may be configured to respond to touch events classified as moisture, for example, by providing a moisture indication to the user and/or to the operating system.

In some examples, the classifier is configured to associate a probability (e.g., confidence level) with each classification. The computing device may further comprise a determiner (e.g., classification post-processor) configured to confirm the classification of the touch event based on the associated probability compared to a classification threshold. The determiner may perform a rule-based analysis utilizing thresholds.

In some examples, a first touch event and a second touch event are indicated in the dataset. The classifier is configured to classify the first touch event as a finger touch and to classify the second touch event as a moisture touch.

In some examples, the touch device comprises a touchscreen and a touchpad.

In some examples, the handler is configured to respond to a touch event classified as a moisture touch by generating a moisture notification.

In some examples, the moisture notification comprises at least one of the following: an indication of a location of moisture on the touch device to an operating system of the computing device; an indication of a location of moisture on the touch device to a user of the computing device; or an indication of a recommendation to a user of the computing device to remove moisture from the touch device.

In some examples, the operating system is configured to adapt a user interface located in an area of the touchscreen associated with the touch event classified as a moisture touch.

In some examples, the classifier comprises a machine-learning (ML) mode. The ML model can be trained using a labeled dataset including a set of classifications comprising at least finger touch and moisture touch.

In some examples, the set of classifications comprises finger touch, palm touch, instrument touch, and moisture touch.

In some examples, the computing device further comprises an adapter configured to adjust at least one of a touch detection sensitivity threshold, a touch profile, a feature weight, and/or a classification threshold based on at least one of the following: receipt of a touch customization; a moisture touch classification; or detection of an ambient environment parameter exceeding a threshold.

In some examples, the touch features comprise at least four of the following touch features: touch location, touch size, touch shape, touch duration, touch consistency, touch dynamics (e.g., shape change, movement pattern), touch clustering, or capacitance intensity.

Methods are described herein. In some examples, a method comprises generating a dataset associated with a touch event on the touch device; determining touch features for the touch event from the dataset; classifying the touch event as a class in a set of classifications comprising at least finger touch and moisture touch based on a touch profile indicated by the touch features; and responding to the classified touch event.

In some examples, the method further comprises associating a probability with each classification; and confirming the classification of the touch event based on the associated probability compared to a classification threshold.

In some examples, a first touch event and a second touch event are indicated in the dataset. The classification may comprise classifying the first touch event as a finger touch and classifying the second touch event as a moisture touch.

In some examples, the response to a touch event classified as a moisture touch comprises generating at least one of a moisture notification displayed to a user or a moisture notification to an operating system of the computing device.

In some examples, the classification is provided by a machine-learning (ML) model. The method may further comprise training the ML model using a labeled dataset including a set of classifications comprising at least finger touch and moisture touch.

In some examples, the method further comprises adjusting at least one of a touch detection sensitivity threshold, a touch profile, a feature weight, or a classification threshold based on at least one of the following: receipt of a touch customization; a moisture touch classification; or detection of an ambient environment parameter exceeding a threshold.

A computer-readable storage medium is described herein. The computer-readable storage medium has computer program logic recorded thereon that, executed by a processor circuit, causes the processor circuit to perform a method. The method may comprise, for example, any combination of operations described herein.

For example, a method may comprise generating a dataset associated with a touch event on the touch device; determining touch features for the touch event from the dataset; classifying the touch event as a class in a set of classifications comprising at least finger touch and moisture touch based on a touch profile indicated by the touch features; and responding to the classified touch event.

In some examples, a first touch event and a second touch event are indicated in the dataset. The classification may comprise, for example, classifying the first touch event as a finger touch and classifying the second touch event as a moisture touch.

In some examples, the response to a touch event classified as a moisture touch comprises generating at least one of a moisture notification displayed to a user or a moisture notification to an operating system of the computing device.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Moreover, according to the described embodiments and techniques, any components of systems, computing devices, servers, device management services, virtual machine provisioners, applications, and/or data stores and their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (e.g., or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (e.g., computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

1. A computing device that includes a touch device, the computing device comprising:
at least one processing device; and
at least one memory device to store program code executable by the at least one processing device to:
perform data collection to generate a dataset associated with touch events on the touch device;
determine touch features for the touch events from the dataset, wherein the touch features include at least a shape change of the touch events;
classify the touch events as a class in a set of classifications comprising at least finger touch and moisture touch based on a touch profile indicated by the touch features; and
respond to the classified touch events.

2. The computing device of claim 1, wherein the program code is is executable to associate a probability with each classification, and the program code is further executable to confirm the classification of the touch events based on the associated probability compared to a classification threshold.

3. The computing device of claim 1, wherein a first touch event and a second touch event are indicated in the dataset, and wherein the the program code executable to classify the touch events is further executable to classify the first touch event as a finger touch and to classify the second touch event as a moisture touch.

4. The computing device of claim 1, wherein the touch device comprises a touchscreen and a touchpad.

5. The computing device of claim 1, wherein the program code executable to respond is further executable to respond to a touch event classified as a moisture touch by generating a moisture notification.

6. The computing device of claim 5, wherein the moisture notification comprises at least one of the following:
an indication of a location of moisture on the touch device to an operating system of the computing device;
an indication of a location of moisture on the touch device to a user of the computing device; or
an indication of a recommendation to a user of the computing device to remove moisture from the touch device.

7. The computing device of claim 6, wherein the operating system is configured to adapt a user interface located in an area of the touchscreen associated with the touch event classified as a moisture touch.

8. The computing device of claim 1, wherein the program code executable to classify the touch events comprises a machine-learning (ML) model and wherein the ML model is trained using a labeled dataset including a set of classifications comprising at least finger touch and moisture touch.

9. The computing device of claim 1, wherein the set of classifications comprises finger touch, palm touch, instrument touch, and moisture touch.

10. The computing device of claim 1, further comprising:
program code executable to adjust at least one of a touch detection sensitivity threshold, the touch profile, a feature weight, or a classification threshold based on at least one of the following:
receipt of a touch customization;
a moisture touch classification; or
detection of an ambient environment parameter exceeding a threshold.

11. The computing device of claim 1, wherein the touch features additionally include at least four of the following touch features: touch location, touch size, touch shape, touch duration, touch consistency, movement pattern, touch clustering, or capacitance intensity.

12. A method, comprising:
generating a dataset associated with touch events on the touch device;
determining touch features for the touch events from the dataset, wherein the touch features include at least a shape change of the touch events;
classifying the touch events as a class in a set of classifications comprising at least finger touch and moisture touch based on a touch profile indicated by the touch features; and
responding to the classified touch events.

13. The method of claim 12, further comprising:
associating a probability with each classification; and
confirming the classification of the touch events based on the associated probability compared to a classification threshold.

14. The method of claim 12, wherein a first touch event and a second touch event are indicated in the dataset, and wherein the classification comprises classifying the first touch event as a finger touch and classifying the second touch event as a moisture touch.

15. The method of claim 12, wherein the response to a touch event classified as a moisture touch comprises generating at least one of a moisture notification displayed to a user or a moisture notification to an operating system of the computing device.

16. The method of claim 12, wherein the classification is provided by a machine-learning (ML) model, the method further comprising:
training the ML model using a labeled dataset including a set of classifications comprising at least finger touch and moisture touch.

17. The method of claim 12, further comprising:
adjusting at least one of a touch detection sensitivity threshold, [[a]] the touch profile, a feature weight, or a classification threshold based on at least one of the following:
receipt of a touch customization;
a moisture touch classification; or
detection of an ambient environment parameter exceeding a threshold.

18. A computer-readable storage medium having program instructions recorded thereon that, when executed by a processing circuit, perform a method comprising:
generating a dataset associated with touch events on the touch device;
determining touch features for the touch events from the dataset, wherein the touch features include at least a shape change of the touch events;
classifying the touch events as a class in a set of classifications comprising at least finger touch and moisture touch based on a touch profile indicated by the touch features; and
responding to the classified touch events.

19. The computer-readable storage medium of claim 18, wherein a first touch event and a second touch event are indicated in the dataset, and wherein the classification comprises classifying the first touch event as a finger touch and classifying the second touch event as a moisture touch.

20. The computer-readable storage medium of claim 18, wherein the response to a touch event classified as a moisture touch comprises generating at least one of a moisture notification displayed to a user or a moisture notification to an operating system of the computing device.
